(19) United States
(12) Patent Application Publication
(10) Pub. No.: US 2006/0080215 A1
(43) Pub. Date: Apr. 13, 2006

(54) Method and system for electronic trading including transactional history

(75) Inventors: Jeff Warsaw, Elkins Park, PA (US); John Handley, Chicago, IL (US)

Correspondence Address: STRATEGIC PATENTS P.C.., C/O PORTFOLIOIP, P.O. BOX 52050, MINNEAPOLIS, MN, 55402, US

(73) Assignee: Wave Rules, LLC.

(21) Appl. No.: 11/097,997

(22) Filed: Apr. 1, 2005

Related U.S. Application Data
(60) Provisional application No. 60/558,686, filed on Apr. 1, 2004.

(51) Int. Cl. G06Q 40/00

(52) U.S. Cl. 705/37

(57) ABSTRACT

The present invention relates to systems and methods of electronic trading. Embodiments involve presenting real-time financial market data in a user interface, wherein the real-time financial market data includes a plurality of adjacent cells containing proposed trade quantities with associated prices; and presenting historical trade quantity and price information in the GUI; wherein the historical information scrolls on the screen as new real-time financial market data is refreshed.

### RELATED APPLICATIONS

This application claims the benefit of U.S. Prov. App. No. 60/558,686, filed Apr. 1, 2004, and entitled “Methods and systems for electronic trading,” the entire disclosure of which is incorporated herein by reference in its entirety.

This application also relates to the following commonly owned United States patent applications file on even date herewith: Atty. Docket No. WAVE-0001-P01, entitled “Systems and methods of electronic trading using automatic book updates”, and Atty. Docket No. WAVE-0001-P02, entitled “User interface for electronic trading.” The disclosure of each of these applications is incorporated herein by reference in its entirety.

### BACKGROUND

1. Field

This invention relates to the field of electronic trading, and more particularly, embodiments of the present invention relate to electronic trading methods and systems adapted to provide a versatile and efficient tool to identify and or act on market opportunities.

2. Description of the Related Art

Electronic trading is beginning to replace open outcry systems of trading. In the open outcry system, participants interact with one another in an immediate fashion essentially free of latency. Electronic trading venues do not enjoy this latency free system of executing transactions. Instead, the remote nature of electronic trading includes inherent delays as a result of several factors including: the time it takes to prepare an electronic trade order through trading software, the time it takes for the submitted trade order to traverse the communications networks, the time for an exchange host to process the trade order, the time to re-traverse the communications networks back to the client, and the time software requires to process the incoming message(s). In addition, the trade orders of other participants need to be processed by software in the form of the “market data feed”. These latencies prevent a synchronous interaction with the market. As a result the market transactions become discrete and fragmented. Trading strategies are continuous in nature and would benefit if they could be implemented without having to wait for pending exchange messages. A need exists for a mechanism to facilitate trading strategies to execute in a virtually continuous state of operations.

Trading exchanges provide for very rapid buying and selling of currency, options, futures, securities, commodities, precious metals or other items (items) by locating the brokers that are placing bids and offers in direct contact through the specialist. All of the information that is required in order to make informed decisions on a buy or sell is very rapidly displayed. Trends may be seen as data is revised in real time on the display screens and the number of brokers buying or selling at a particular post indicates activity. The brokers may adjust trading strategies based on the information market trends that are seen at these exchange trading posts.

One phenomenon common to trading exchanges is rapid fluctuations in prices, whether for currency, options, futures, securities, commodities, precious metals or other items. Prices typically vary in small fractions. Rapid market fluctuations offer opportunities for arbitrage, where a trader both buys and sells very large offsetting quantities of the same item, taking advantage of small fluctuations in the price between the times of the transaction. For example, if at 4:04:10 p.m. the price of a security is $45.00 and five seconds later at 4:04:15 p.m. the price of the same security is $45.25, then purchasing one million shares at 4:04:10 p.m. and selling one million shares five second later at 4:04:15 p.m. results in a gain of twenty-five cents for each of the million shares, or a total gain of $250,000. Conversely, if the price dropped by $0.25 cents during that time, then selling at the later time would have resulted in a loss of $250,000. High-volume arbitrage transactions are extremely time-sensitive. Movement of a market price by even a single fractional unit can result in gains or losses of millions of dollars. Thus, if a trader fails to execute a trade at the desired time, instead executing the trade a few seconds later, disaster can result if the market swings even a small amount during the period of the delay.

A need exists for electronic trading systems that allow for very rapid development and implementation of complex trading strategies. A need also exists for electronic trading systems that allow traders to visualize market trends, such as trends relating to very small fluctuations in market prices.

### SUMMARY

Methods and systems are provided herein for a computer system to support electronic trading, which can be conducted remotely from an exchange. The computer system can include a graphical user interface (GUI) that presents a user with current and recent historical data about the volume of contracts traded at different price points in the market. The computer system can include an application programming interface (API) that allows the system to store and execute trading instructions in response to user input or market data. The API can, for example, store rules that provide for the execution of trades at machine speed if events occur that trigger operations of the API.

Provided herein are the methods and systems enabling electronic trading that provide a client software program having a graphical user interface (GUI) and an application programming interface (API), where the API is integrated with the GUI. The system provides a server network for enabling trading transactions based on a user's interaction with the GUI, allowing the GUI to display in real time the accumulation of contracts placed in a market at each of a plurality of prices. This invention may allow trades to be as executed at speeds limited only by the computing power of the hardware running the application and the performance of the network infrastructure utilized.

In an embodiment the invention provides a system that interacts with the market exchanges where the GUI may display the current volume of contracts and a history of the volume of contracts placed and executed at previous periods of time. The GUI and the API interact within a host computer system for all trades and the host computer system provides the connection the market exchanges. The color of an accumulation of contracts in the GUI may represent whether executed contracts were bids or offers. Real time securities data may be displayed in the GUI and may provide for user input. The GUI may interact with an API that may execute all trades based on a trading strategy input into the GUI and/or API by the user.

In an embodiment the GUI may display item information in a grid presentation providing rows and columns. On the right side of the GUI may be displayed a price scale column that provides prices in the incremental units that the trade item may be bought or sold for. The GUI may display an accumulation of contracts executed at the item price adjacent to the item price column providing a visual of contracts executed at the adjacent price. As the item price changes the contract history may scroll to the left of the GUI providing a visual of contract volume execution trends. In the contract history the number of executed contracts on the bid may be shown in red and the number of executed contracts on the offer may be shown in blue. The contract history may indicate a trend up if the number of executed contracts on the offer are greater than the number of executed contracts on the bid while the trend may be indicated to be down if the reverse is true. The current accumulated contracts for an item price may be displayed adjacent to the item price, five market offers and five market bids may be displayed adjacent to the associated item price. In an embodiment the user may be able to mouse click or keyboard indicate in the column of the item price to buy or sell contracts. The price column may be where the user indicates buy and sell information as to number of contracts for a given item price. Once the buy and sell strategy is indicated in the book column the API may act on book by using predefined user parameters. In an embodiment the GUI may display views of the API activity that indicate completed or pending buy and sell orders.

In an embodiment the API may execute all of the item buys and sells in concert with the book indications of the GUI. With the API executing all of the trades it allows the user to concentrate on providing strategies of the individual items. The user may maintain the trade strategies in the API by use of user adjustable parameters that may be set for individual items. In an embodiment an API interface may allow the user to select different user defined non-routable orders that may provide trade cancellation dependent on trade conditions. The user may also be able to set minimum and maximum contract buys or sells. The user may also establish rules for the maximum long and short positions for an item.

In an embodiment the client software may be configured in a way to allow for bundling execution of commands. This bundling of command capability allows the users to maintain pace with the very rapidly changing market exchanges. Macros may be defined for the twelve “F” keys of the user's keyboard. Each “F” key may have a number of keystrokes or mouse clicks assigned to it. These user predefined macros may be executed by pressing a key to execute a complete action that may be a buy submit immediately, sell submit immediately, join bid, join offer, cancel best ask, cancel best bid, cancel next best bid, or other trading action. By use of this type of rapid keystroke method, to complete an entire action, the user may be capable of rapid response to the changing market by not being required to take time to select a series of menu options to complete an action.

In an embodiment the user develops strategies for trading in the GUI where the user sets long, short, quantity, and price strategies for an item. A target book may be constructed and transmitted from the GUI to the API where the API may make all trades by applying user parameter rules. The API may execute all buys or sells at machine speed to achieve the user strategies that may be defined in the GUI. The API may seamlessly interact with order book from GUI and may create all exchange buy or sell tickets. In an embodiment the API may evaluate the actual and target state of the user strategy. The API may then calculate the difference between actual state and target state and may place all buy or sell orders to achieve the user's target state. The API may automatically buy, sell, cancel, manage orders, or other needed trade processing seamlessly and transparently to the user. The API trade information may be displayed in the GUI to allow the user to completely understand the strategy executed in the GUI verses the activity of the API trading to achieve the overall strategy.

In an embodiment data may be transmitted across the system with a proprietary messaging scheme that may contain market and exchange information. The data may be compressed, encrypted, and stored as a small binary message that provides for enhanced data through put. The data may be expressed in integral tick values as offsets from the best bid and best offer. The data may further be expressed as deltas in the market instead of the entire market data set. These ticks may further allow for smaller message sizes that support the required data transmission speed. The encoding of the data may be machine independent allowing for faster interpretation of the messages and greater portability.

In an embodiment the network of servers may provide a link from the GUI and API to market exchanges. The GUI and API may communicate with a Daemon which may then communicate with a server where the GUI and API may be on different client stations than the daemon and/or server. For speed considerations the API may reside on an environment such as Linux while the GUI may operation within a Windows environment. The server system may consist of a Client and API, Daemon server, market data server, order server, authentication server and credit server for the communication of trades to the exchange markets. The GUI and API may communicate with the Daemon server, which may pass data to the order servers. The Daemon, market data, and order servers may exchange data with the authentication server to verify the validity of trades. The order server may communicate with the credit server to verify user account and credit information that may include maximum drawdown, maximum single order size, maximum aggregate order size. Once all of the verification within the server system is complete the market trade may be submitted.

In an embodiment the servers may be HTTP based and the application may generate error exceptions if needed. The HTTP servers may allow clients to take action to resolve problems when a message is sent to the user about an error. The messages sent may suggest the type of actions a user may take to resolve an issue. These error exceptions may take place in real time allowing for the user to resolve issues before trades are jeopardized. In this manor the network system may be a method of automated support for some issues.

In an embodiment, the interface of a contemplated commodity trade may display a price bar that may continually center the current ask/bid prices. The price bar may be dynamic in the display of the current commodity prices; it may move the ask/bid prices in conjunction with the associated book, order, and trade information, maintaining the current commodity price in the center of the display.

In an embodiment, selecting a price for bid or ask may be indicated by the use of an input device such as a mouse or keyboard. Because the price bar may be displaying current commodity prices dynamically, a method that requires a double action to indicate a trade may be provided to the user. One action of an input device, such as the down click of a mouse, may indicate the selection of price for a trade. The action of maintaining the down click of the mouse may allow the user to transit the GUI pointer over the full range of the displayed commodity prices. This action may allow the user to adjust to the dynamics of the commodity and trigger a trade at the desired time. A contract may be created for the indicated commodity price with a second action of an input device, such as the up click of a mouse button. This allows the user to instantaneously indicate the desired trade of the commodity.

In an embodiment, once the second action of the input device has completed, the GUI may display the resulting bid or ask status near the selected price. The appropriate bid or ask quantity may also be displayed on the GUI in additional status windows.

In an embodiment, interfaces may be provided that indicate the commodity trade history and analysis. Interfaces may be provided that show the commodity bid/ask history in relation to the working bid/ask prices. A deviation chart may be provided to show the difference of the commodity price in relation to a regression line and standard error lines. A scatter diagram may be provided to show the comparison of a first contract price to a second contract price.

In an embodiment, a graphical interface may display a time-based bid/ask price history in relation to working bid and working ask prices. The time may be displayed using set intervals that may be user determined. In an embodiment, the graph may provide the user with a historical reference as to the commodity performance during the displayed time period.

In an embodiment, a graphical interface may display a time-based commodity price in relation to a regression line. The graph may display a regression line, standard error lines, and the working bid/ask lines. In an embodiment, this graph may allow the user to view the trends of the commodity over time versus the regression trend line.

In an embodiment, a graphical interface may display a scatter diagram relating a first contract price with a second contract price. In an embodiment, the scatter diagram may display a regression line, standard error lines, working bid/ask lines, and historical data of trades. In an embodiment, a user may use the scatter diagram to determine the trend of a stock, either positive or negative, to aid in the selection of future purchases or sales of the commodity.

In embodiments, systems and methods of electronic trading are presented including historical information. Such systems and methods may involve presenting real-time financial market data in a user interface, wherein the real-time financial market data includes a plurality of adjacent cells containing proposed trade quantities with associated prices; and presenting historical trade quantity and price information in the GUI; wherein the historical information scrolls on the screen as new real-time financial market data is refreshed.

In embodiments, an electronic trading system may be adapted to assist a participant in the trade of stocks, bonds, funds, products, or other transaction vehicles.

### BRIEF DESCRIPTION OF FIGURES

The invention may be understood by reference to the following figures:

FIG. 1 shows a trading post for an exchange.

FIG. 2 shows the configuration of an embodiment of a host computer system for supporting trading.

FIG. 3 shows a graphical user interface for a trading system.

FIG. 4 shows an API interface for a trading system.

FIG. 5 shows one of the configuration screens for the API interface.

FIG. 6 shows the interaction of the GUI and API for trading.

FIG. 7 is a flow diagram relating to the operation of the API.

FIG. 8 shows the GUI and API as separate computer environments.

FIG. 9 shows an architecture for the host computer system.

FIG. 10 shows an interface for a daemon in the trading system.

FIG. 11 shows an order book in the GUI.

FIG. 12 shows a message format for handling messages in a computer trading system.

FIG. 13 illustrates seamless integration between the GUI and the API.

FIG. 14 shows a high level flow chart of the process of selecting and setting a contract of a commodity.

FIG. 15 shows the GUI for selecting a buy of a commodity, using the price bar.

FIG. 16 shows the GUI for setting the contract of the selected commodity buy price.

FIG. 17 shows the GUI for the selecting the ask price of a commodity, using the price bar.

FIG. 18 shows the GUI for setting the contract of the selected commodity ask price.

FIG. 19 shows the graphical interface time-based display of the bid/ask prices of a commodity.

FIG. 20 shows the graphical interface deviation chart of a commodity price in relation to a regression line.

FIG. 21 shows the graphic interface scatter diagram comparing a first contract price to a second contract price.

FIG. 22 illustrates a GUI with auto-adjusting column widths.

FIG. 23 illustrates a GUI with cursor locking.

FIG. 24 shows the GUI with a new price series starting and a historical price series

FIG. 25 shows the GUI with the existing price series updating and a historical price series

FIG. 26 shows the GUI with a new price series starting and a historical price series' scrolling

FIG. 27 illustrates a GUI with cursor locking.

### DETAILED DESCRIPTION

Exchanges throughout the world utilize electronic trading in varying degrees to trade stocks, bonds, futures, options and other products. These electronic exchanges are based on three components: exchange computers (host), communications servers (server), and the exchange participants' (trader) computers (client). The host's operations include order-matching, maintaining order books and positions, price information, and managing and updating the database for the online trading day as well as nightly batch runs. The server's operations include managing communications between the host and client. The client's operations include maintaining local copies of order books and positions, price information and placing and receiving responses to orders to buy and sell products. Client computers allow traders to participate in the market. Client computers run software that display interactive trading screens on the traders' desktops. The trading screens enable traders to enter and execute orders, obtain market quotes and monitor positions. The range and quality of features available to traders on their client computers varies depending on the specific software application being used to interact with the server and/or host.

Electronic exchanges have volatile products with prices that move rapidly. To profit in these markets, traders must be able to react quickly. A skilled trader utilizing a client computer running the fastest software, with the highest speed communications and the most sophisticated analytics can significantly improve his own or his firm's profitability. Any speed advantage can significantly improve the trader's ability to profit in an electronic market with rapidly moving prices. In today's trading markets, a trader lacking a technologically advanced means of interacting with the trading market is at a severe competitive disadvantage.

Electronic markets generally require the same information from every trader and send the same information to every trader regardless of the trader's means of interacting with the electronic market. The prices bid for products and asked for products in the market make up the market data and all traders can receive this information if the exchange provides it. Similarly, every exchange requires that certain information be included in each order such as the product name, price, quantity, restrictions and other pieces of information that can be specified. Trading markets will not accept orders without all of the required information properly specified. This input and output of information is the same for every trader.

In existing systems, multiple elements of an order must be entered prior to an order being sent to market, which is time consuming for the trader. Such elements include the commodity symbol, the desired price, the quantity and whether a buy or a sell order is desired. The more time a trader takes entering an order, the more likely the price on which he wanted to bid or offer will change or not be available in the market. The market is fluid as many traders are sending orders to the market simultaneously. Successful markets strive to have such a high volume of trading that any trader who wishes to enter an order will find a match and have the order filled quickly, if not immediately. In such liquid markets, the prices of the commodities fluctuate rapidly. On a trading screen, this results in rapid changes in the price and quantity fields within the market grid. If a trader intends to enter an order at a particular price, but misses the price because the market prices moved before he could enter the order, he may lose hundreds, thousands, even millions of dollars. The faster a trader can trade, the less likely it will be that he will miss his price and the more likely he will make money.

An aspect of the present invention may be characterized as trade-by-wire trading. In embodiments, trade-by-wire trading involves a concept of specifying desired market exposure in a target book and not directly creating trade orders. In embodiments, an engine reconciles requests for the addition, modification, and/or removal of market exposure into exchange format compliant orders. This decoupling relieves the trading strategy from logging specific ticket numbers. The ticket numbers may be required to be submitted to the exchange for all cancel or change requests. By transferring the burden of this management to the target/actual engine the trading strategy may deal in intuitive trading terms rather than in low level messaging specifications. For example, a trader or participant may desire scenarios such as “I want to be long 5 at 100.55. Now I want to be long 3 at 100.55. Now I want to be long 3 at 100.54” In this example, the trader simply submits its current desired exposure to the target/actual engine without suspending its processing until a latent exchange message containing a ticket number arrives. Another example of the efficiency of this paradigm is the handling of a cancel all request. A human trader may desire to cancel all working orders and may give such instruction. Generally, only orders with ticket numbers can be cancelled when the cancel all instruction is received. If any orders have pending confirmations they can not be cancelled until their pending state has ended. This would require the human trader to submit an additional cancel all request after pending orders have received their confirmations. In a fast moving market, a trader is likely to prefer submitting a single cancel all requests and have the system achieve the desired state. In embodiments, this is accomplished by removing all desired exposure from the target book. Pending orders will be immediately cancelled when their ticket numbers arrive as there would be no corresponding request for exposure in the target book.

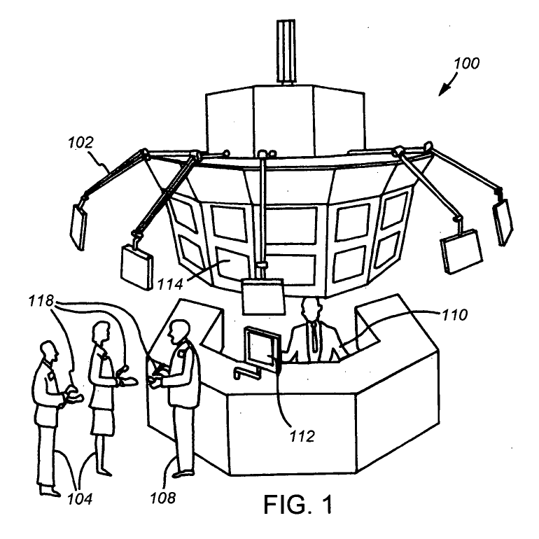

A wide variety of items are traded in exchanges, including stocks, options, futures, and other securities, bonds, commodities, precious metals, currencies, contracts and a other items. Traditional exchanges, such as the New York Stock Exchange, have become increasingly automated. FIG. 1 shows an embodiment of a trading post 102 for an exchange 100. Traders 104 buy and sell items through the item specialist 108 in a direct open trading market. A specialist trading assistant 110 assists the specialist 108 by operating the point of sale station 112 that maintains all the information the specialist 108 needs to assist traders 104 in trades. The various display screens 114 allow the traders 104 access to the available information for the rapid trade process. The traders and specialists can also have available wireless data systems 118 that transmit buy and sell information to the point of sale station 112 rapidly. This entire infrastructure allows for rapid adjustment to changing markets over the trading day. Accordingly, traders who once traded in live trading floors in paper transactions increasingly trade through the assistance of computers. Computer trades also take place remotely from the exchange, such as through computer networks. Thus, computer systems exist for supporting trading; however, such systems suffer a number of drawbacks.

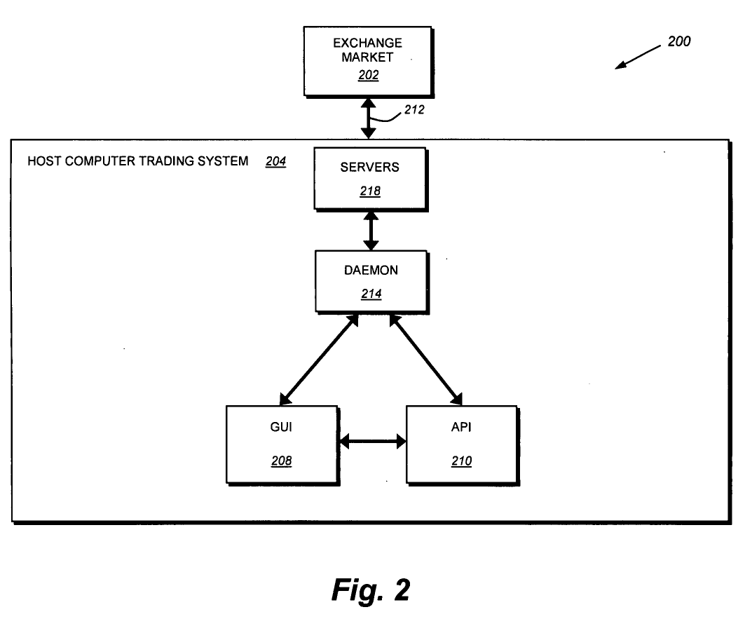

FIG. 2 shows an embodiment of a computer-based trading system 200. The trading system 200 is comprised of a computer system for an exchange market 202 and a host computer trading system 204 for hosting trading activity, such as by traders 104 within a brokerage firm. The exchange market 202 may be any type of exchange market 202, such as a stock exchange, options, futures, or other securities exchange, commodities market, precious metals market, currency market, oil or gas exchange, energy exchange, or other exchange where items are exchanged pursuant to contracts that are executed at varying prices. The computer system for the exchange market 202 may exchange information with the host computer trading system 204, such as across a network 212. For example, the computer system of the exchange market 202 may publish information about current market prices for various items, information about offers to purchase the item at various prices and quantities, information about offers to sell the item at various prices and quantities, information about trades that have been executed in the past, and other information relating to the exchange market 202. The host computer trading system 204 can receive the information over the network 212. The host computer trading system 204 can send various information to the exchange market, such bids to purchase, offers to sell, instructions to execute trades, limit orders, cancellations, and other instructions relating to trading. The computer system of the exchange market 202 in turn can send confirmations of executed trades, acceptance of bids to purchase or offers to sell, execution of cancellations, and the like. The network 212 can include any kind of network, such as a dedicated T1 line, a DSL line, a cable connection, an Ethernet network, the Internet, a local area network, a wide area network, a virtual private network, a wireless network or other kind of network.

The host computer system 204 can include a number of modules, including a graphical user interface 208, one or more application programming interfaces 210, one or more servers 218, as well as various computer system elements, such as an operating system (such as a Windows®, Linux®, Unix®, or MacIntosh® operating system), a keyboard, mouse, joystick, trackball, pointer, or other input device, communication ports, such as serial or USB ports, data storage facilities, such as databases and memory, and the like.

The graphical user interface (GUI) 208 may be the interface for the user where trading strategies are developed and executed. The GUI 208 may work in an environment such as Windows® to take advantage of the graphical capabilities and communicate with the other components of the host computer trading system 204. The GUI 208 may present various objects with which a user can interact, such as by using a keyboard, mouse pointer, cursor, or other input device. Using the input devices, a user can trigger various events through the GUI, such as executing trades, entering bids to purchase or offers to sell, canceling orders, placing contracts at various prices, highlighting information, or triggering other elements of the host computer trading system 204, such as macros, programs, and application programming interfaces (APIs) 210. More details of the GUI 208 are provided below.

The host computer trading system 204 may also include one or more application programming interfaces (APIs) 210. The API 210 may interface with the GUI 208 and the other elements of the host computer trading system 204. The API 210 is a programming environment that allows the user to conveniently develop programs, such as programs that support and execute trading strategies. For example, the API 210 can allow a user to establish trading rules, such as rules that set limits relating to the prices at which trades are to be executed, rules that relate to the positions the trader holds in particular items, rules related to positions the trader wishes to hold, rules related to limits on trading activities, rules related to limiting exposure to changes, rules to generate automatic execution of trades, rules to generate automatic cancellation of trades, rules to execute algorithms that relate to trading and a wide variety of other trading rules. Further details of the API 210 are provided below. One feature of the API 210 is that it allows the host computer trading system 204 to evaluate conditions that occur very rapidly and to trigger actions when the market hits a limit condition. Thus, through the GUI 208 a human trader can make decisions at a strategic level, but the host computer trading system 204 can execute those strategies automatically, providing speed in execution of a transaction when the specified market condition is met (such as to stop a loss instantly when the market ticks down to the price at which a stop loss order is placed) and providing discipline (such as to execute a stop loss order even if the human trader might be tempted to allow the trade to ride on the hope that the market will tick back upward, an action that can lead to catastrophic losses if the trader is wrong). The API 210 can be programmed to establish many rules. For example, stop loss orders can be automatically ratcheted up if the market price rises after the time the original stop loss order was placed.

In embodiments the host computer trading system 204 includes a daemon 214. The daemon may be a software agent for managing interactions among the GUI 208, the API 210, and the host computer trading system 204. For example, the Daemon 214 may handle orders placed in the GUI 208, such as orders to purchase or sell an item, or to place contracts to purchase or sell items at particular prices. The Daemon 214 can take the orders from the GUI 208 and deliver them to the network 212 for delivery to the exchange market 202. Similarly, the daemon 214 can handle messages between the GUI 208 and the API 210, such as feeding the API 210 events from the GUI 208 so that the API can operate on the events.

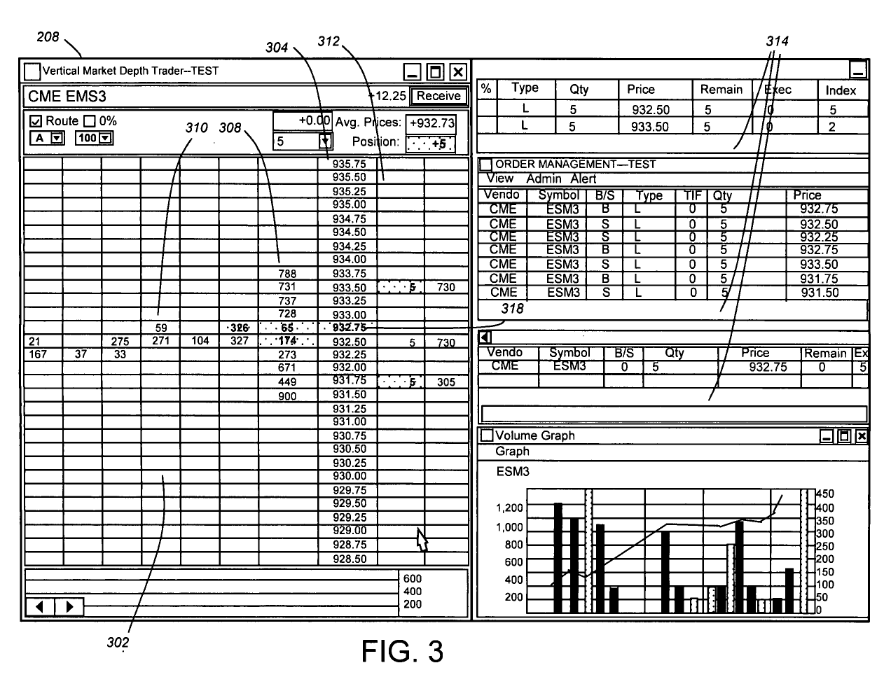

FIG. 3 shows an embodiment of the GUI 208. The GUI 208 may display item information in a grid presentation 302 providing rows and columns. On the right side of the GUI 208 a price scale column 304 may be displayed that shows a scale of prices in small increments, such as increments of $0.25 for the particular item to be traded, in this case a security. The current price 318 at which the item is trading may be highlighted in the scale 304, such as by showing the price in a different color, such as blue, than the other prices in the scale.

The GUI 208 may present a different grid 302 for each item to be traded. In embodiments, the GUI 208 may include more than one grid 302 at a time, such as by including four or more grids as panes in the GUI 208 on a computer screen. Thus, the trader can watch multiple items at the same time through different similar grids 302 within the GUI 208.

The grid 302 of the GUI 208 may display a scale 308 showing an accumulation of contracts related to the item to be traded, where the different positions on the scale 308 contain the number of contracts available for the item at various prices. Bids to purchase may be presented in one color, such as blue, and offers to sell may be presented in another color, such as red, with the number of such contracts at each price point being presented vertically along the price scale.

As price of the item changes contract history cells 310 showing the number of contracts executed at past points in time at price points may scroll to the left of the grid 302 providing a visual depiction of contract trends. In the contract history cells 310 offers may be shown in one color, such as red, and the bids may be shown in another color, such as blue. The differing colors allow the user to rapidly distinguish offers to sell from offers to buy, the price scales allow the user to rapidly visualize the prices at which offers are made, and the numbers allow the user to compare the number of contracts offered at the different prices. Thus, the user can obtain a great deal of information very rapidly. Moreover, the information is similar to the information that a trader experiences in a trading pit, including current price information, quantities of contracts offered, and past contracts executed.

The grid 302 of the GUI 208 can help a user understand market trends. For example, the quantities in the scale 308 of current offers to purchase and sell and the quantities in the contract history cells 310 allow the user to compare the number of offers to purchase and the number of offers to sell at the current time and at recent points in the past. If the number of offers to purchase dramatically exceeds the number of offers to sell, then market prices tend to tick upward in order to clear the discrepancy between demand and supply of contracts at the current price. By watching the trends in the numbers of contracts in the scale 308 and the contract history cells 310, a trader can thus make an inference about the direction of the next movement of the market and execute trades that reflect that understanding. Thus, the quantities in the scale 308 and cells 310 may indicate a trend up if number of offers to buy (bids) are greater than offers to sell (asks), while the trend may be down if number of offers to sell (asks) are greater than offers to buy (bids).

In the scale 308 the current accumulated contracts for items at various prices at a given point in time may be displayed adjacent to the item price. The scale can show any number of prices with contracts or a specified number, such as the five best market offers and five best market bids.

The GUI 208 can include a book column 312 to allow a trader to see the number of contracts that are currently in the market for the plurality of prices displayed and to cancel orders by price. In an embodiment the user may be able to mouse click or make another keyboard input to indicate in the book column 312 contracts the trader wishes to cancel at given prices, such as a desire to cancel an item at a given price. The price column may be where the user indicates buy and sell information as to number of items for which the trader wants to place contracts for a given item price.

In embodiments the book column 312 can interact with the daemon 214; for example, the daemon 214 can take orders placed that are displayed in the book column 312 and execute them in the exchange market 202. In embodiments the daemon may facilitate the application of rules created using the API 210 on the orders displayed in the book column 312.

The API 210 may act on the book column 312 by using predefined user parameters. In an embodiment the GUI 208 may display panes 314 that contain market information, information about positions, information about the API 210, or other information.

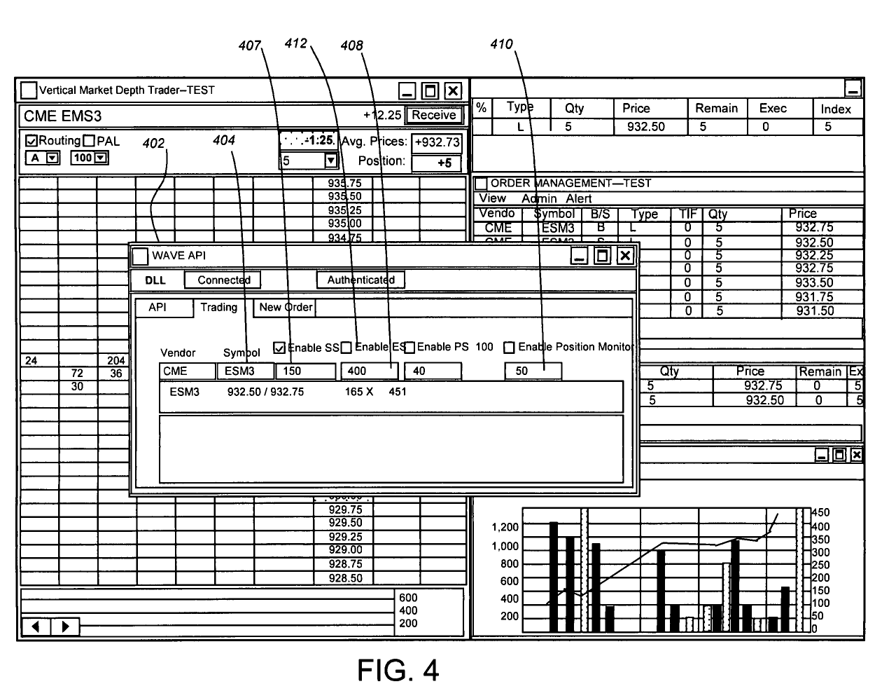

FIG. 4 shows an embodiment of an interface 402 for the API 210. The user may use the API interface 402 to set parameters for items 404 that relate to trading. In an embodiment an API interface 402 may allow the user to select different smart stops 412 that may provide automatic trade cancellation up the occurrence of certain conditions. The user may also be able to set minimum 407 and maximum 408 contract buys or sells. The user may also establish rules for the maximum long and short values 410 for an item. These user defined parameters work with the daemon 214 and GUI 208 to execute trades, generate market buy or sell tickets, cancel orders, or the like.

One embodiment of the API 210 allows the user to define and execute a virtual book of orders. In trading activity, traders often execute a number of different trades for the same item at various prices and place a number of different orders for the item at different prices, so that it can be difficult to determine rapidly what the trader's position in a particular item is at a given time. As a result, while a trader may have a good sense of what position the trader would like to hold in the marketplace (such as to be short or long by a certain amount), the trader may not easily know how many contracts to place in order to achieve that position, because positions and contracts already placed may not be known in rapid fashion. Accordingly, using the API 210, a trader may create a virtual book that defines the trader's desired position with respect to an item. Once the trader sets the virtual book, such as in the GUI 208, the rules from the API 210 may be executed, importing information about the trader's current positions and the orders already placed, but not executed, by the trader. The rules generated with the API 210 can then automatically determine what orders need to be placed and/or cancelled in order to convert the user's actual position and contracts into the desired position in the marketplace. Once the actions are determined, the daemon 214 executes the actual order placement and trades to achieve the result specified in the virtual book. Through the interaction of the rules generated by the API 210, the virtual book defined by the user in the GUI 208 and the execution by the daemon of the rules to convert the user's actual positions into the desired positions, the host computer system 204 allows the trader to focus on desired positions, never having to consider the details of what positions have already been accumulated, what trades have already been executed, what orders have been placed, or the like. The daemon 214 automatically handles the tickets for the actual trading transactions, placing and canceling orders automatically in view of the virtual book and the rules generated using the API 210. The automatic execution of trades allows the trader to have more time to study the market and allows the trader to react instantly to changes in the marketplace, rather than having to consider current positions and contracts before taking action. In situations like the arbitrage situation described above, where having long and short positions match up over very short time frames is important, and where execution of the transaction requires precise timing on very short time scales, the automatic execution allows the trader to reduce the margin of error by giving the trader a better chance of executing the transaction that the trader intended and doing so at the time the trader desires.

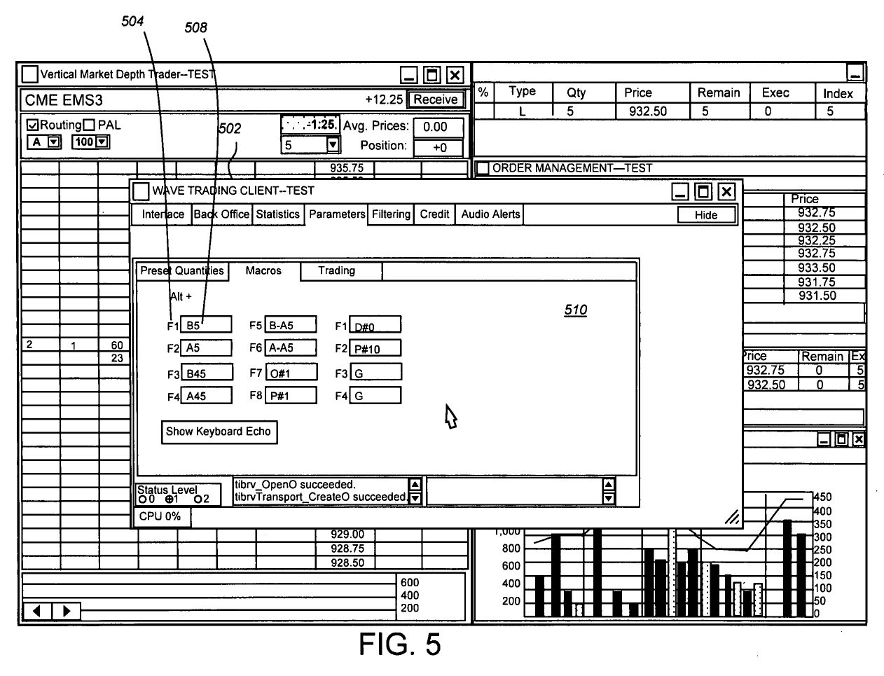

FIG. 5 shows the embodiment of one of the GUI configuration screens 502 for the creation for macros 510. Macros may be defined for the twelve function keys 504 of the user's keyboard. Each function key 504 may have a number of key strokes or mouse clicks 508 assigned to it. For example, holding the “alt” key and the F1 key may trigger a particular action. These predefined macros may be executed by pressing a key combination to execute an action. Examples of actions that can be enabled as macros include a buy submit immediately, sell submit immediately, join bid, join offer, cancel best ask, cancel best bid, cancel next best bid, or other trading action. Macros allow execution of trading actions by a rapid keystroke method, to complete an entire action very quickly, so that the user may be capable of rapid response to the changing market by not being required to take time to select a series of menu options to complete an action. Not only function keys, but other inputs can be adapted to perform rapid actions through macros 510. For example, a joystick or game controller can be adapted to provide input to the GUI 208, with certain actions defined to execute particular transactions very rapidly.

In embodiments, additive trading interactions are done within the price column, all deleting trading interactions are done within the book column.

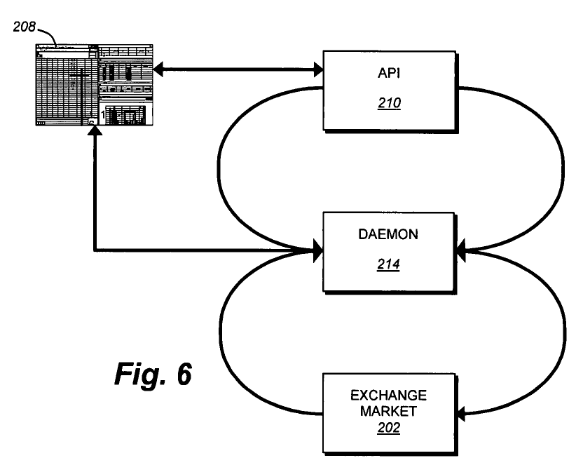

FIG. 6 shows the embodiment of the interaction of the GUI 208, API 210, host computer system 204, and exchange market 202 for trades. The user may maintain a trading strategy for an item in the GUI 208 by indicating a contract buy or sell in the book column associated with an item price. The GUI 208 book column 304 may communicate with the API 210 and the daemon 214 as to a buy or sell event. The API 210 may determine buy and sell actions required to attain the user's desired trade position and may also analyze the buy and sell actions to determine whether they conflict with any rules set in the API 210, such as rules set to limit exposure to losses. Guided by the rules formed in the API 210, the daemon 214 may execute trades or cancellations and may communicate with the exchange market computer system 202 to verify the actions. If a trade is authorized then the daemon 214 may communicate the buy or sell to the exchange market 202. Once the exchange market 202 trade is complete the communication may be back to the host computer system 204, daemon 214, API 210 and GUI 204, where the buy or sell may be displayed.

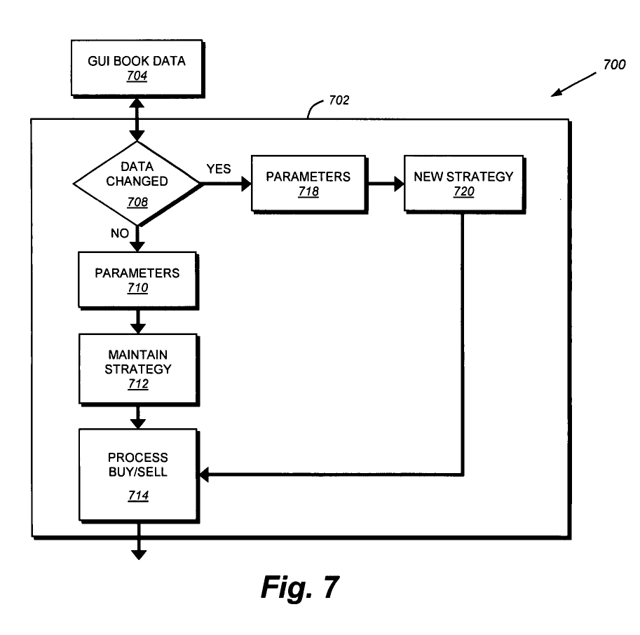

FIG. 7 shows a flow diagram 700 with steps for an embodiment of the interaction of the API 210 with the GUI 208 to support a virtual book trade strategy. The user trade strategy may be executed between the virtual book represented in the GUI 208 and the API 210. An API check sequence 708 may compare the GUI book data 704 with existing data previously received to determine if there is a change in strategy. If a change in strategy state is detected at the check sequence 708 the new state may be applied to the API parameters 718 and a new buy and sell strategy 720 may be executed to attain the desired state. If the API check sequence 708 determines the strategy state to be the same then the parameters 710 may be applied and the buy and sell strategy may be maintained 712. Once a new strategy 720 or maintain strategy 712 is created the process of buy and sell 714 process may continue with the host computer system 608 network.

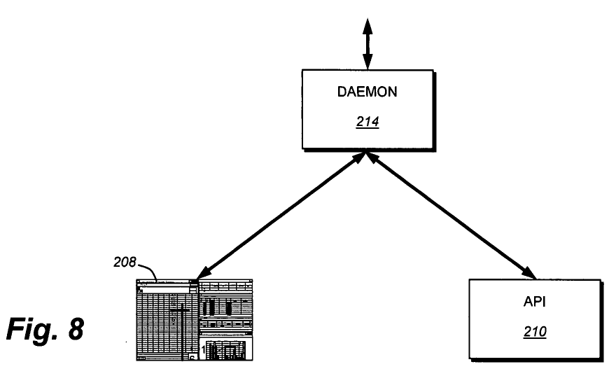

FIG. 8 shows the embodiment of a possible configuration of the GUI 208, daemon 214 and API 210 as separate computer environments. To maintain the very rapid interaction with the exchange markets the daemon 214 and API 210 may take advantage of the execution speed of a computing environment such as Linux. In this way the API 210 and daemon 214 may be separated from the slower graphical requirements of the GUI 208. The GUI 208 may work in a Windows® environment to take advantage of the graphical capabilities. The GUI 208 and API 210 operate on separate machines to take advantage of the requirements of each environment, with the daemon 214 handling interactions between them. The daemon 214 may also operate on a separate machine, such as a Linux workstation. The GUI 208 and API 210 may communicate through the daemon 214 to receive and transmit trade information to each other and the market.

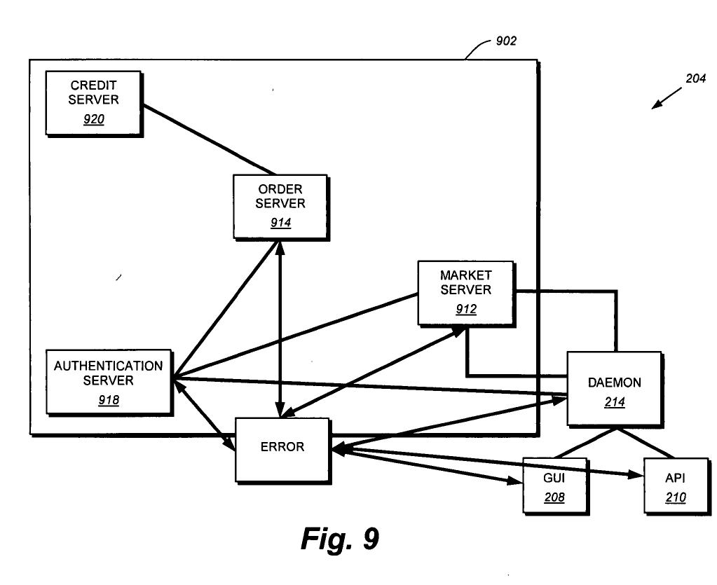

FIG. 9 shows an embodiment of an architecture for the host computer trading system 204. The GUI 208 and API 210 communicate with a Daemon 214 where the GUI 208 and API 210 may be on different client stations. For speed considerations the API 210 may reside on an environment such as Linux while the GUI 208 may operate within a Windows® environment. In addition to the daemon 214, the host computer system 204 may include a plurality of servers 218, such as a market server 912 for handling market information between the host computer trading system 204 and the market exchange 202, an order server 914 for handling orders, cancellations, and other trading actions between the host computer trading system 204 and the market exchange 202, an authentication server 918 for authenticating transactions, such as using an encryption facility, digital signature, or other authentication facility, and a credit server 920 for validating account information to ensure that sufficient credit exists for the trader to execute a desired trade or order. The GUI 208 and API 210 may communicate with the Daemon server 214, which may pass data to the market server 912 and order server 914. The Daemon 214, market server 912, and order server 914 may exchange data with the authentication server 918 to verify the validity of trades. The order server 914 may communicate with the credit server 920 to verify user account information. Once all of the verification within the server system 218 is complete the market trade or other action may be made. There may be a market server 912 and order server 914 for each market exchange 202, or a single market exchange 202 may have many servers, such as if the host computer system 204 hosts many traders and additional servers are needed to ensure adequate bandwidth and processing capacity to handle high volumes of trading rapidly.

FIG. 9 also shows an embodiment of exception error reporting. The host computer system 204 may be a HTTP based exception server capable of broadcasting messages to allow users to take corrective action. If an anomaly in the exchange market 202 or host computer system 204 occurs, an error message 908 may be broadcast in the form of an email or other appropriate message. The message may be displayed on the user GUI 208 and may provide some instruction as to action that may be taken. The user may be able to resolve an anomaly and resume trading rapidly. This user capability of notification and resolution may be an example of automated support.

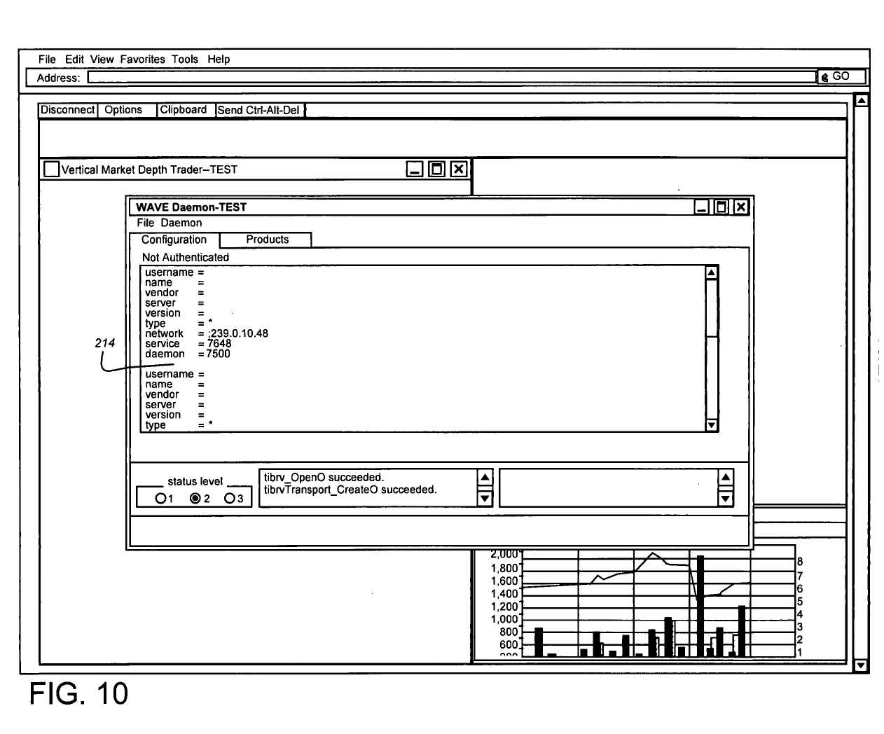

FIG. 10 shows an interface to the daemon 214, which may run on a Linux box, Unix box or similar machine with the API 210 to allow faster computing speeds than are possible with a machine that supports the GUI 208.

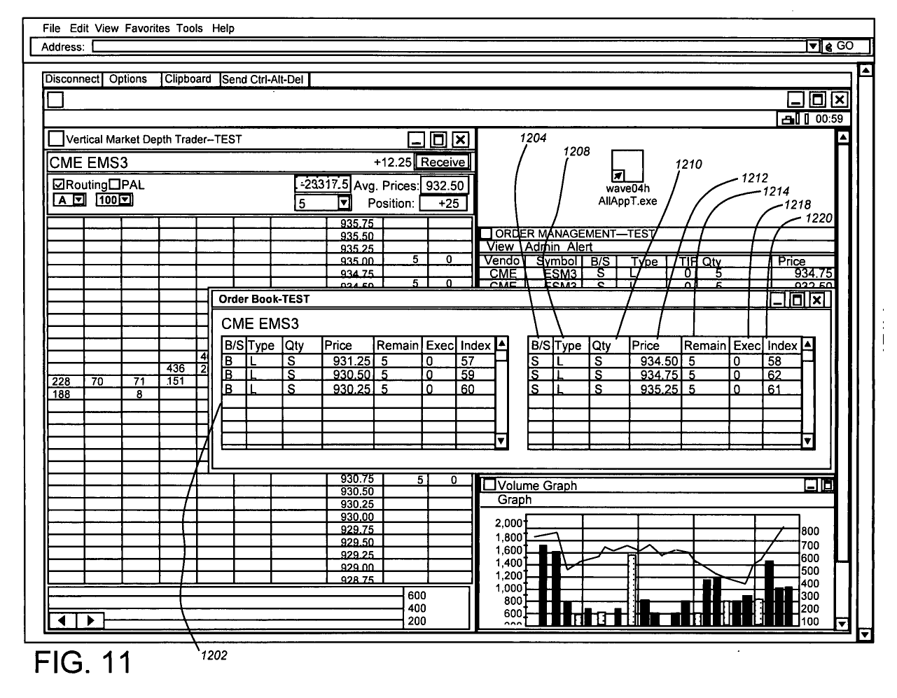

FIG. 11 shows the GUI 208 with an order book 1202. The order book 1202 uses a two-column format, similar to the formats understood by traders, where sell orders and buy orders are kept separate. Each side of the order book 1202 includes a buy/sell column 1204, an order type column 1208, a quantity column 1210, a price column 1212, a remainder column 1214, an executed column 1218 and an index column 1220 for representing information about orders in the order book 1202. The order book 1202 allows a trader to obtain rapid, clear information about the status of buy and sell orders.

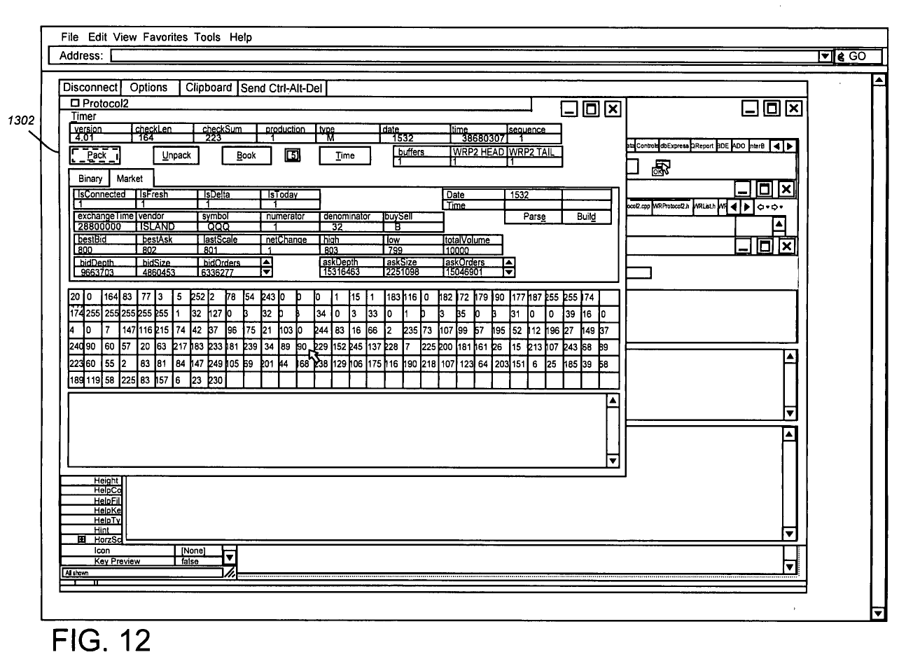

FIG. 12 shows a format 1302 for a message for a particular market exchange 202. In embodiments, the host computer trading system 204 uses compressed, encrypted binary messages to ensure speed of transmission. Information regarding trades is compressed to a minimal data set, such as by containing a bit indicating the latest tick, from which the market price can be derived, rather than containing a string that represents the entire market price. In the format 1302, the storage quantity can be adjusted to reflect the minimum number of bytes needed to represent a market message. The messages are coded in machine-independent form, so that the messages can be read in a Windows® environment or other graphical environment and can also be read in a Unix or Linux environment. For example, a binary representation of an integer is handled differently between Windows® and Linux environments. Thus, the message format can break messages into ASCII bytes rather than integers, allowing the messages to remain machine-independent, so that the GUI 208 can run on one platform while the daemon 214 and API 210 run on a different platform.

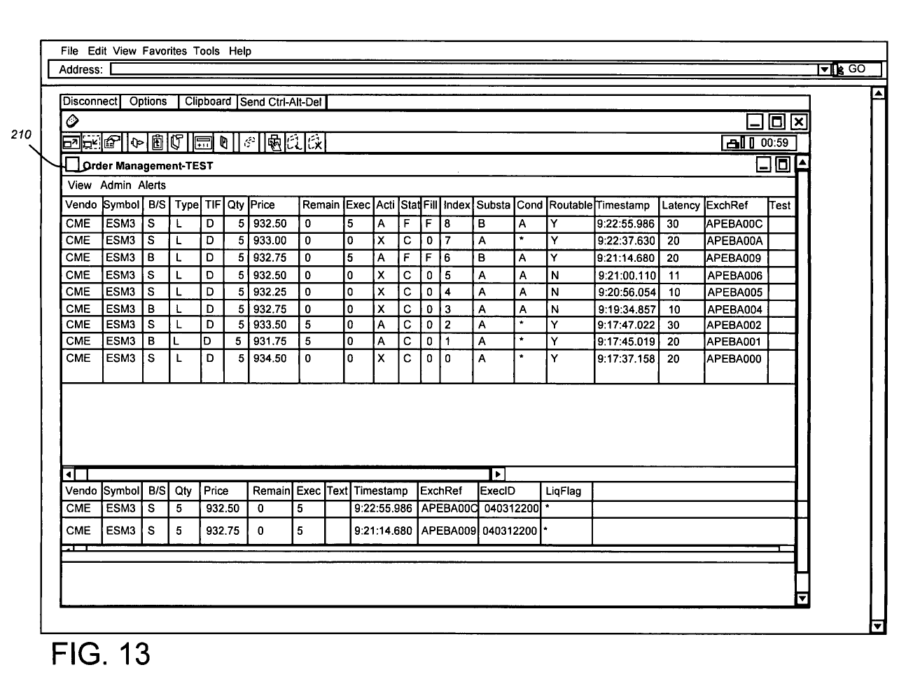

Referring to FIG. 13, the API 210 may be seamlessly integrated with the GUI 208, so that the trader sees what the API 210 is doing at any given time when looking at the GUI 208, and the API 210 sees events created by the trader when the trader interacts with the GUI 208. A virtual book in the GUI 208 transmits information to the API 210. Instead of requiring the trader to keep track of orders, it allows the trader to keep track of “perfect world” positions. The API 210 then determines the difference between the “perfect world” positions in the virtual book and the trader's actual positions. The API 210 then hands instructions to the daemon 214 to cause it to execute transactions that eliminate the difference between the desired position and the actual position. Thus, the trader can think in conventional trading terms, such as “I want to be long 50.” The API 210 and daemon 214 cancel orders, place orders, and the like to get the trader to the position of being long 50, regardless of what the trader's earlier position was. The trader does not have to know anything about the specific orders that have been placed or even think about specific orders. The trader just indicates the degree of exposure, price, quantity, and symbol in the GUI 208 and the API 210 and daemon 214 of the host computer trading system 204 determine the current state, interpret the differential between the current state and the desired state, and place and/or cancel orders to arrive at the desired state. Unlike conventional APIs, which usually require a trader or an employee to work in complex exchange messaging protocols, the API 210 is a simple interface that allows a trader to specify common trading rules, such as limit orders, stop loss orders and the like. The trader deals in comfortable terms such as “long,” “short,” “quantity” and “price,” rather than having to work with specific orders, tickets or the like. The API 210 and daemon 214 deals with turning the current position into the trader's ideal position by automatically buying, selling, canceling and managing orders. For example, if the trader has ten orders in and wants to be long 20, then the host computer trading system 204 could read an input of “long 20” in the GUI 208 and automatically add ten more orders to get the trader to the long 20 position. An advantage of the invention is that the trader is not required to submit orders or to provide the exchange with a ticket number. Management of ticket numbers with a market exchange 202 can be quite complex, and the methods and systems described herein allow the trader to completely sidestep the process, freeing up valuable time to focus on market information.

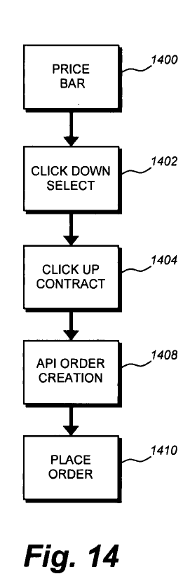

In FIG. 14, a high level flow chart of an embodiment of a trade method is shown. A price bar 1400 may be provided for the user to view the prices of a particular commodity. The price bar 1400 may be divided into ask prices and bid prices; the bid and ask prices may be indicated by different colors in the interface. The price bar may be dynamic in the display of the current commodity prices by adjusting the display of the prices to maintain an equal number of displayed ask and bid prices. The ask and bid prices may continually change, based on the market value of the commodity as it is traded on an exchange. For example, the price bar may be adjusted so as to continually center the current market price on the display.

As the user is viewing the trading interface, the user may decide to make a bid or ask trade. In an embodiment, the user may select 1402 a price to make a bid or ask using an input device such as a mouse or keyboard. The user may need to make rapid bid/ask decisions as to which displayed price will be selected 1402 as the trade price. The price bar may be changing as the commodity price, book, and order market information is updated. In an embodiment, the user may be able to start the bid/ask process by providing a down click and hold of a mouse. This action may allow the user to move the bid/ask indicator over the entire displayed commodity price bar to make the price selection 1402. In this way, the user may be able to select 1402 the prices based on all of the inputs provided by the interface.

In an embodiment, once the user is satisfied that the buy/sell indicator is selecting 1402 the desired price, the user may up click the mouse to set the order 1404 for the bid/ask. This action may allow for very rapid decisions by the user, based on the market information displayed on the interface. The up click action may start the order 1404 process and may display order 1404 information such as the number of commodities bought/sold, a revised book price, and the status of the trade. Executing the order 1404 may send information to the API order creation 1408 to apply the rules of the API 1408 to the executed order. Based on the user rules in the API 1408, an order may be placed 1410 to the appropriate exchange and the order status may be updated on the trade interface.

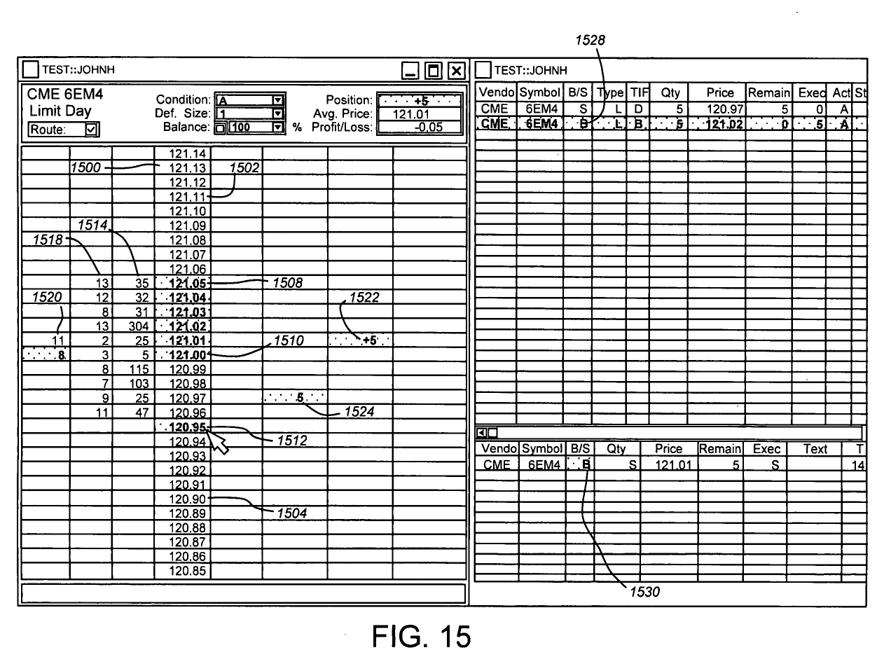

In FIG. 15, the trade interface for selecting a bid is shown. The price bar 1500 may display the current bid and ask market prices. The price bar 1500 may be dynamic; it may maintain a display of an equal number of bid and ask prices on the interface. In an embodiment, the ask 1502 prices may be displayed as one color at the top of the price bar 1502 and the bid 1504 prices may be in a second color at the bottom of the price bar 1502. The price bar 1502 may be further divided by highlighting the ask book price 1508 and the bid book price 1512 in different color intensities. The interface may also maintain columns showing the book quantity 1514, order quantity 1518, trades 1520, net position 1522, and any computer generated orders 1524.

To select a bid/ask price to place a order, the user may indicate a bid/ask price on the price bar 1500 with an input device such as a mouse or keyboard by positioning the bid/ask indicator over the desired price. An ask order may be selected by moving the indicator to the ask price 1502 side of the price bar 1500 and a bid may be selected by moving the indicator to the bid price 1504 side of the price bar 1500. Because the price bar 1500 may be dynamically updating market information, the user needs a selection method capable of implementing rapid decision-making. A two-step action from an input device may be used to select and order a trade. In an embodiment, a user may use a mouse to select the desired price with a down click and hold action. This may allow the user to move the indicator over the price bar 1500 to indicate 1512 a bid price. An order may not be placed as long as the user continues to hold the mouse button in the down position.

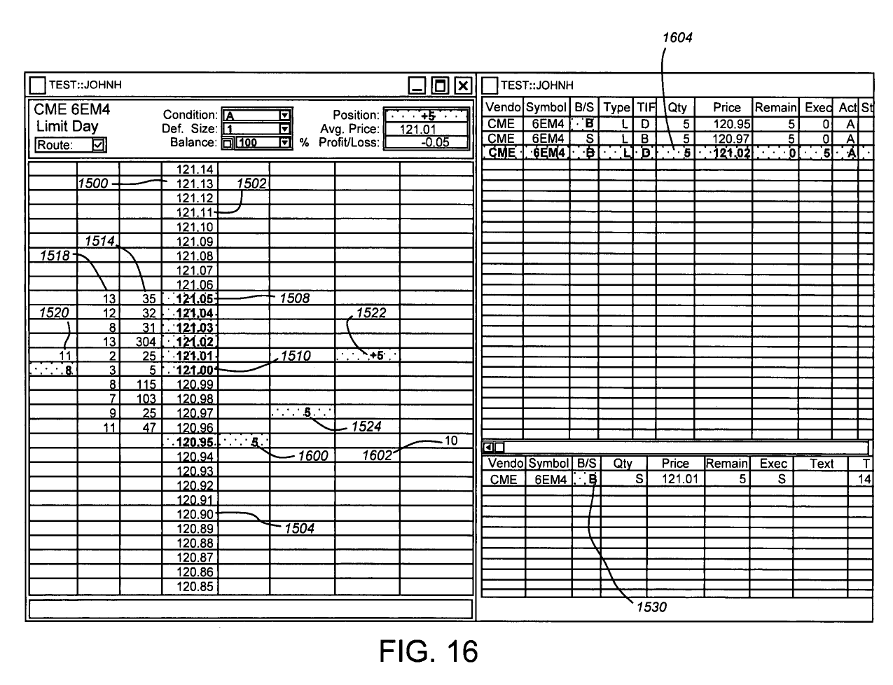

In FIG. 16, the trade interface ordering a bid is shown. In an embodiment, after the user has selected 1512 a bid, as described in FIG. 15, the order may be executed by the action of the up mouse click. In an embodiment, the mouse up click action may transmit information to the API to execute an order per the established trading rules. After the mouse up click, the order quantity 1600 may be placed adjacent to the price that was selected as described in FIG. 15. The book quantity 1514, orders 1518, and trades 1520 may also be updated with the execution of the trade 1600. A trade status window 1604 may be updated to add the most recent trade to the existing trades in the status window 1604 list. The bid in the status window 1604 may be displayed using the same color as the bid in the price bar 1500. Once an order is executed it may be displayed in the trade completion window 1530.

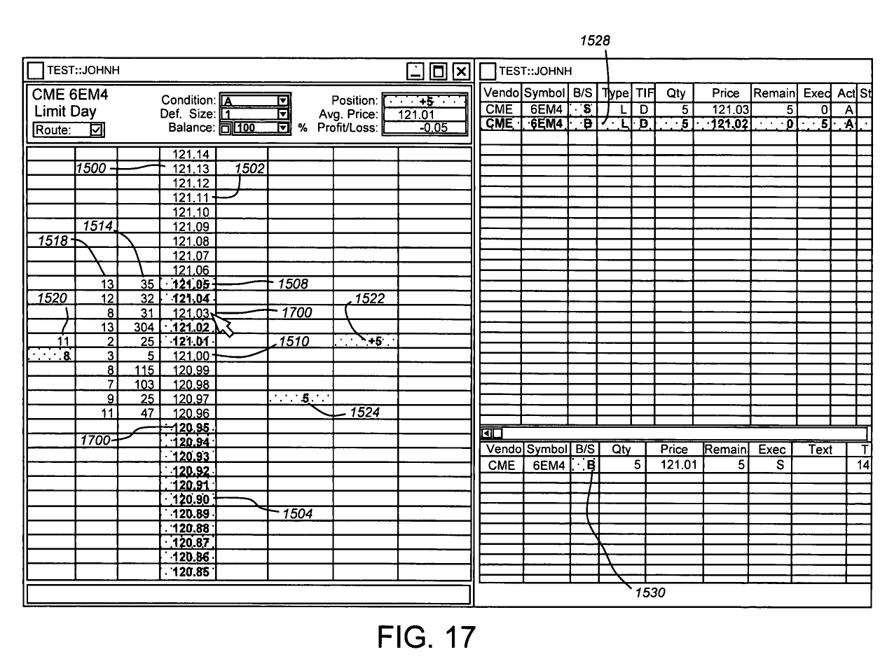

In FIG. 17, the trade interface for selecting an ask price is shown. Using the selecting process described in FIG. 15, the user may select a desired ask price 1700. In an embodiment, as long as the user continues to hold the mouse button down, the user may be able to scroll over the price bar 1500 and view the changing market of the commodity before implementing the ask order.

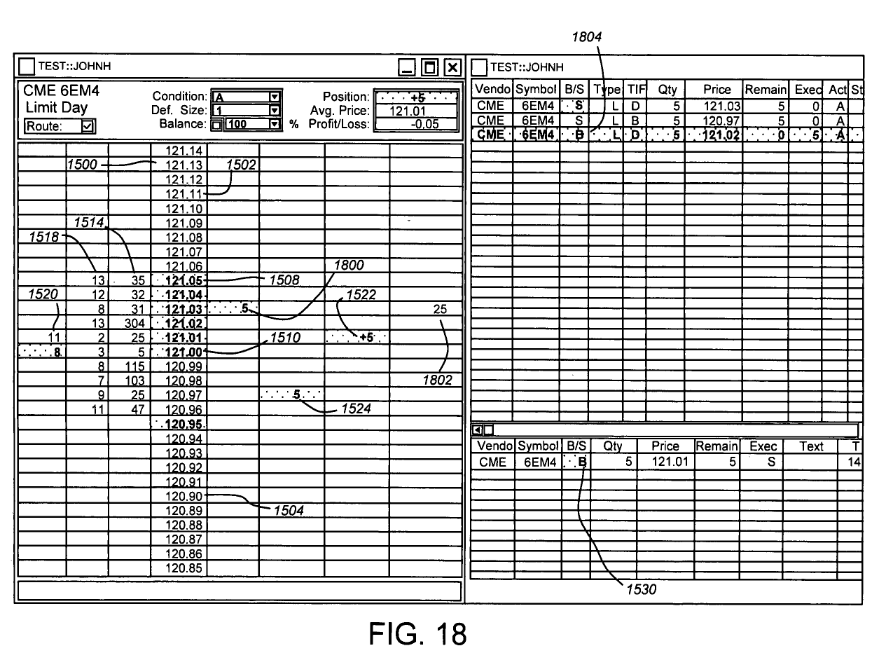

In FIG. 18, the trade interface executing an ask order is shown. Using the method described in FIG. 16, the user may be able to execute an ask order 1800. Once the user has selected the desired ask price, the order may be executed by the action of the up mouse click. In an embodiment, the mouse up click action may transmit information to the API to execute an order per the established trading rules. After the mouse up click, the order quantity 1800 may be placed adjacent to the price that was selected as described in FIG. 17. The book quantity 1514, orders 1518, and trades 1520 may also be updated with the execution of the trade 1800. A trade status window 1804 may be updated to add the most recent trade to the existing trades in the status window 1804 list. The bid/ask field in the status window 1804 may be displayed using the same color as the ask price 1504 in the price bar 1500. Once an order is executed it may be displayed in the trade completion window 1530.

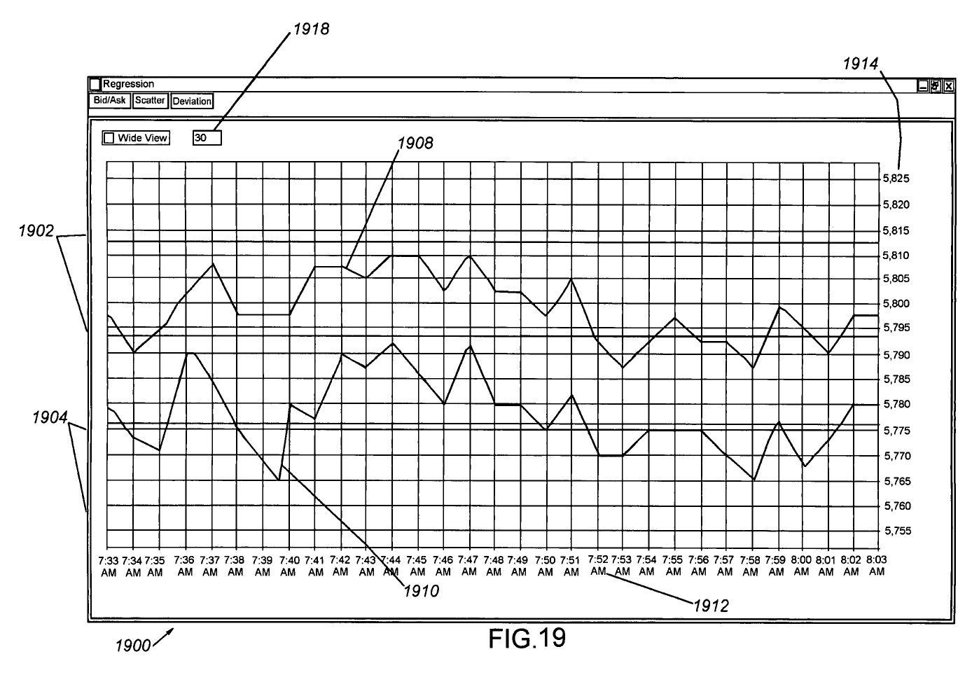

In FIG. 19, the bid/ask price history interface 1900 is shown. The bid/ask price history interface 1900 may provide a historical view of the commodity price versus time 1912. This interface may provide information to the user about the recent performance of the commodity of interest. Often the past performance of a commodity may be an indicator of future trends and may aid the user in selecting and executing an order.

The user may be able to determine the amount of time displayed in the view by entering a time period in the selection window 1918. The history interface 1900 may provide the historical market ask price 1908 and market bid price 1910 for the time period selected 1912. The market ask price 1908 may be displayed in relation to the working ask price 1902, and the market bid price 1910 may be displayed in relation to the working bid price 1904.

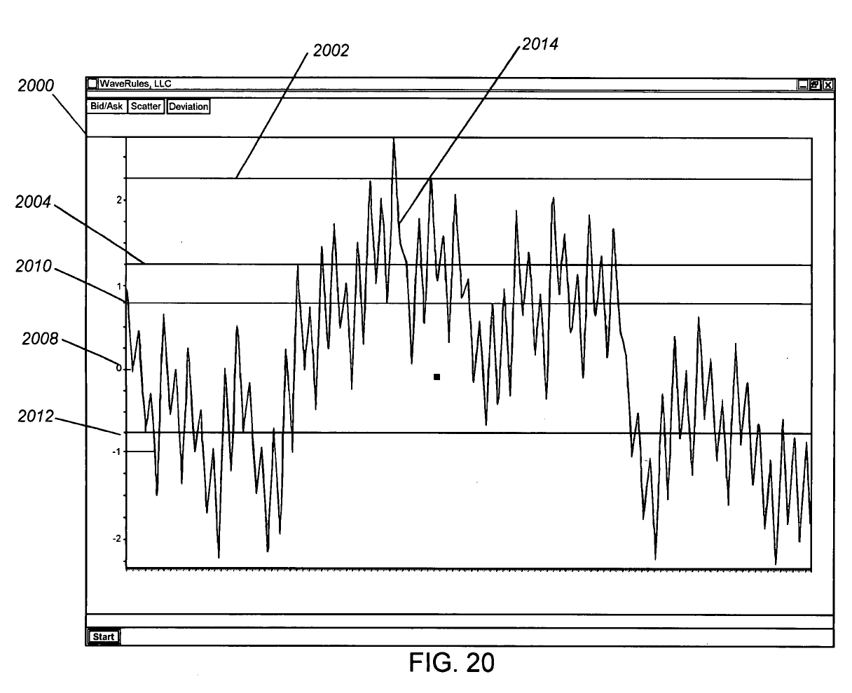

In FIG. 20, a deviation chart interface 2000 for the commodity is shown. The user may review the commodity prices compared with a regression line to further understand the performance of the commodity on the exchange. The regression line is a straight line that is a best fit through all of the available data points. Displaying the commodity price in relation to the regression line may provide a detailed view of the commodity performance in relation to a base line price. The deviation chart interface 2000 may also display up to three standard error lines, working ask price line, and working bid price line.

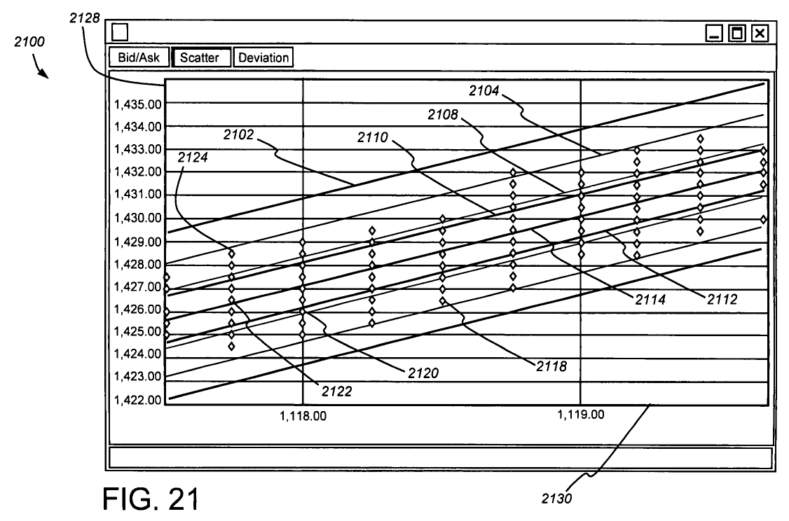

In FIG. 21, a scatter diagram 2100 for the commodity is shown. A scatter diagram is used to plot two sets of variables against each other to determine the relation of one variable to the other. A trend line may be developed based on the plotted data of the two variables. The trend line may be a regression line 2114 and up to three standard error lines 2102 2104 2108. The regression line 2114 may be fit to the data points of the two variables to provide a trend; an up sloping line may show a positive response to an input, and a down sloping line may show a negative response to an input.

The scatter diagram 2100 may plot a first order 2128 to a second order 2130 to determine the type of return a commodity is providing. The historical bid 2118 and historical ask 2124 data points may be plotted for the selected orders. A regression line may be automatically plotted for the historical ask price 2124 and historical bid price 2118 and may show a return trend for the commodity. In an embodiment, the scatter diagram 2100 shows a positive trend with the regression line 2114 sloping up from left to the right. For comparison purposes, the working ask price 2110 and working bid price 2112 may be displayed on the scatter diagram 2100.

An aspect of the present invention relates to methods and systems adapted to process exchange order book information and exchange trade information to facilitate the explicit knowledge of the character of order flow that floor traders enjoy. The first step may be to determine whether a trade published from an exchange is a bid trade or ask trade. Some exchanges provide this information explicitly in their trade messages; however, most do not. In embodiments where an inference is required to determine the information, the accuracy of that calculation may be dependent on two factors: 1) the completeness of the order book and trade information published and 2) the time synchronization of book and trade messages. A series aggregates bid and ask trade quantities until the bid/ask prices are breached or turned. If the side of the trade can not be determined a guess may be made against current or future messages, the trade information can be ignored, or it may be counted as an unknown trade whose series can last only one trade.

### NEW SERIES EXAMPLES

100.0 bid trade→100.0 ask trade
   Market Turn
100.0 ask trade→100.0 bid trade
   Market Breach
100.0 ask trade→100.01 ask trade
   Market Breach
100.0 bid trade→99.99 bid trade
   Market Breach
100.0 ask trade→100.01 bid trade
   Market Breach
100.01 bid trade→100.0 ask trade

Method:

| 1) | |
|---|---|
| B/A | |
| 100.00/100.01 | 500 × 200 |
| Trade | |
| 100.0 | 10 lots |
| Infer 10 lots traded on the bid. | |
| Bid trade count: 10 | |
| Ask trade count: 0 | |
| 2) | |
| B/A | |
| 100.00/100.01 | 490 × 200 |
| Trade | |
| 100.01 | 100 lots |
| Infer 100 lots trades on the ask | |
| Bid trade count: 10 | |
| Ask trade count: 100 | |
| 3) | |
| B/A | |
| 100.00/100.01 | 490 × 100 |
| Trade | |
| 100.00 | 20 lots |
| Infer 20 lots traded on the bid | |
| Bid trade count: 30 | |
| Ask trade count: 100 | |
| 4) | |
| B/A | |
| 100.01/100.02 | 35 × 700 |
| Trade | |
| 100.01 | 5 lots |

New series. Market has turned and the trade at 100.01 is no longer trading on the previous bid.
Infer 5 lots traded on the new bid
Bid trade count: 5
Ask trade count: 0
   Completeness:

Some exchanges deliver “netted” states of the market. This is the practice of publishing the state of the exchange order book and last sale information only after regular intervals have elapsed. The result of this strategy is to omit some data that is required to produce the exact picture of what is trading in total and to which side of the book trades are occurring. Inferences made with incomplete information can be indeterminate or incorrect.

### Example 1

B/A Last

| | |
|---|---|
| 100.00/100.01 100.00 | → Published |
| 100.01/100.02 100.01 | → Not published |
| 100.00/100.01 100.01 | → Published. |

In this example the 100.01 trade appears to be a trade that occurred by taking the offer when in fact it was actually a trade of hitting the bid. The omitted message obscured the reality of what happened.

### Example 2

| | |
|---|---|
| 100.00/100.03 100.00 | → Published |
| 100.01/100.03 100.01 | → Not published |
| 100.00/100.02 100.01 | → Published |

In this example the last sale is 100.01. The bid before the trade was 100.00 and the ask was 100.03. Neither of these prices match the trade price of 100.01. It is in the middle. If a trade occur in between the known bid and ask no accurate inference can be made about its side traded. Only guesses are made.

Synchronization:

Some exchanges publish order book information and trade information in separate messages. The arrival of these messages may or may not represent the exact sequence of the order matching at the exchange. Trade messages can often arrive in advance of their accompanying order book messages. Sometimes it can be the reverse. Time stamps are usually provided in both messages but the resolution of the time stamp may be inadequate resolve exact chronologies. Modem trading environments generally require at least millisecond resolution where often only second resolution is provided in messages.

### Example 1

Book: 100.00/100.01
Trade 100.02

This example shows a trade of 100.02. 100.02 is through the offer. This situation can imply an ask side trade if the trade message is early or a bid side trade if the message is late.

### Example 2

Book: 100.00/100.05
Trade 100.02

This example shows that the trade occurred in between the bid and ask prices that we have. In embodiments, we may not be able to know which side the trade occurred. It may be possible to guess by waiting for subsequent order book messages if the trade message is early or look back if the trade message was late.

An aspect of the present invention relates to compression of information relating to trades. Market data that consists of bids to buy products, offers to sell products, high and low traded prices, the last price traded, whether the last trade was to buy or sell, etc. is the vast majority of information provided by trading exchanges in terms of the volume of information provided. The set of prices that currently have buy orders combined with the set of prices that currently have sell orders for a given product constitutes the order book for that product. The numbers of different prices that currently have buy orders plus the number of different prices that currently have sell orders within the order book at any given moment in time constitutes the depth of market for that product. Some exchanges provide the complete depth of market, which means all buy order prices and quantities and all sell order prices and quantities within the order book, while other exchanges provide a limited depth of market such as the 5 best buy order prices and quantities and the 5 best sell order prices and quantities. When existing buy or sell orders are filled for a given product or new buy or sell orders are added for a given product or existing buy or sell orders are removed for a given product, the updated order book information for that product is provided by the exchange.

The format for the information that the exchanges provide may consist of readable text with a known ordering where each item in the information stream may be separated by a known delimiter or a fixed format where each item appears in a particular place in the information stream or tags that identify each item in the information stream followed by the item itself. Or, the format for the information that the exchanges provide may consist of a non-readable binary data where each item appears in its native format, such as an integral value, real value or text value, as represented on the computer platform where the information was generated. In embodiments, these formats may be compressed to minimize the volume of data and/or encrypted for security. The two things in common to many of these methods is that the depth of market, whether complete or a subset, such as the 5 best bids and 5 best offers, is provided each time there are changes to the information and that the storage required to provide this information is dependent upon the magnitude and quantity of numeric data provided. For example, to represent the price 119.01 in readable text would require 6 bytes of storage plus 1 byte for a delimiter or N bytes for a tag that identifies the value depending upon the number of bytes required to represent the tag or N bytes for a fixed format depending upon the number of bytes required to represent the largest possible value for that item. To represent that price in a native format, such as real value, may require 4 or 8 bytes depending on the computer platform used.

Embodiments of the present invention relate to compression methods. For example, the data compression method described below reduces the amount of storage required to provide this information significantly by representing price information using the integral units that the product can be traded in, known as ticks, and by representing order book and depth of market information in tick offsets from the best bid or best ask price and by representing all values within a given message using the minimal amount of storage an item type requires within a given message. In addition, the data compression method provides a length and checksum to validate the contents of a given message as well as a means of encrypting each message individually using a different key.

For example, a product that trades in integral units, or ticks, of 0.01 would be converted from price representation into tick representation by dividing the price by the tick size 0.01.

Assuming the following values for a market data message:

| | |
|---|---|
| Tick Size: | 0.01 |
| Best Bid: | 119.00 |
| Best Ask: | 119.01 |
| High: | 121.00 |
| Low: | 115.00 |
| Last: | 119.00 |

| | |
|---|---|
| Best Bids | Best Asks |

| Quantity | Price | Price | Quantity |
|---|---|---|---|
| 100 | 119.00 | 119.01 | 150 |
| 50 | 118.99 | 119.02 | 75 |
| 75 | 118.98 | 119.03 | 25 |
| 25 | 118.97 | 119.04 | 50 |
| 15 | 118.96 | 119.05 | 35 |

In embodiments using the data compression method described below would result in the following market data message represented using ticks and offsets as follows:

| | |
|---|---|
| Best Bid: | 11900 |
| Best Ask: | 11901 |
| High: | 12100 |
| Low: | 11500 |
| Last: | 11900 |

| | |
|---|---|
| Best Bids | Best Asks |

| Quantity | Offset | Offset | Quantity |
|---|---|---|---|
| 100 | 0 | 0 | 150 |
| 50 | 1 | 1 | 75 |
| 75 | 2 | 2 | 25 |
| 25 | 3 | 3 | 50 |
| 15 | 4 | 4 | 35 |

The largest order quantity in the order book is 150 which can be represented in one byte of storage and the largest offset in the order book is 4 which can be represented in one byte so each entry in the book would only require 2 bytes of storage.

In addition, the depth of market on the buy and sell sides can be variable from 0 to N and may be different from each other. For example, there may be a set of 50 prices with buy orders and a set of 10 prices with sell orders in one market data message and then a set of 25 prices with buy orders and a set of 15 prices with sell orders in the next market data message. The respective numbers of entries for each side are sent with the market data message itself along with the storage requirements for each field so that each message contains the minimum amount of information required to represent that set of market data.

The data compression method described below uses integral representation to encode all numeric values and encodes these integral numeric values in a way that is independent of the native data types for a given computer platform. For example, integral values on a 32 bit Intel platform generally use 4 bytes to store a value regardless of the magnitude of the value which means that whether that value is 0 or 1,000,000,000, the same amount of storage is required. The data compression method described below evaluates the magnitude of the integral values and determines the minimum amount of storage required to represent that value. In order to minimize the amount of storage for a set of data such as the depth of market the largest magnitude quantity and largest magnitude offset for the entire depth of market is determined and the minimum amount of storage required to store the largest respective value is used for each quantity and offset value in the depth of market.

In embodiments the compressed data may or may not be encrypted. Encrypted compressed data may be decrypted at some point. In embodiments, values that require less than a single byte to be represented may be compressed using the minimum number of bits necessary to represent the compressed values. Values that require a plurality of bytes to be represented may be compressed using the minimum number of bytes necessary to represent the compressed value. Values that require a plurality of bytes to be represented may be compressed in a way that is independent of the native data types are represented across different hardware platforms and operating systems. Values that may be signed may be compressed. Values that may be unsigned may be compressed. Compression may contain an indication of the length of the compression. Compression may contain the checksum of the compression. Compression may contain a numerator value and denominator value to calculate the tick size of the data. Compression may contain whether the market data server is connected. Compression may contain whether the market data is timely or delayed. Compression may contain whether the market data is a delta from a previous market data set or a complete market data set. Compression may contain a sequence number indicating the complete market data sequence number within a market data set sequence. Compression may contain a sequence number indicating the delta sequence number within a complete market data sequence. Compression may contain whether the market data is current or historical. Compression may contain the exchange time the market data was generated. Compression may contain the vendor and symbol of the market data. Compression may contain the best bid, best ask, last sale, net change, high and low prices. Compression may contain the total volume, bid depth and ask depth. Compression may contain the tick offset from the best bid or best ask, size of the book at that tick offset and number of orders at that tick offset for the plurality of book entries. Compression may contain the full bid depth and ask depth of prices for a complete market data set. Compression may contain only the book entries that have changed since the last complete market data set for a delta market data set.

An aspect of the present invention relates to systems and methods adapted to auto size columns and or rows within a graphical user interface to suit the size of incoming data and/or other information. In embodiments, the size of a column and or row may expand and or order in coordination with data appearing in the row and or column. For example, trading data and or information may be received through trader systems described herein and the data and or information may not fit into the column currently displayed on the GUI. In embodiments, the column would automatically expand to permit the data and or other information to be fully presented. In another example, data may be removed from the column or updated in the column and the data and or other information may not take up all of the column space. In embodiments, the column would then be regulated by the largest number in the column and if the largest number was smaller than that presented earlier, the column width may auto reduce in width. This auto-sizing is considered quite valuable in maximizing the available space within the GUI. In embodiments, data presented in a column may have the width of column adjusted periodically to accommodate the widest data value in the column as determined by the font. In embodiments, the column may be adjusted to fit the widest data value that has existed in the column but that may no longer be present. In embodiments, the column may be adjusted to fit the widest data value that currently exists in the column. In embodiments, the column may be grouped with other columns to form a grid. The columns in a grid may be adjusted to span the width of the grid display such that each column is the approximately the same width. The columns in a grid may be adjusted to span the width of the grid display such that a portion of the columns are adjusted to fit the widest data value that has existed in the column but that may no longer be present and the remaining columns are adjusted to span the remaining width of the grid display such that each remaining column is the approximately the same width. The columns in a grid may be adjusted to span the width of the grid display such that a portion of the columns are adjusted to fit the widest data value that currently exists in the column and the remaining columns are adjusted to span the remaining width of the grid display such that each remaining column is the approximately the same width.

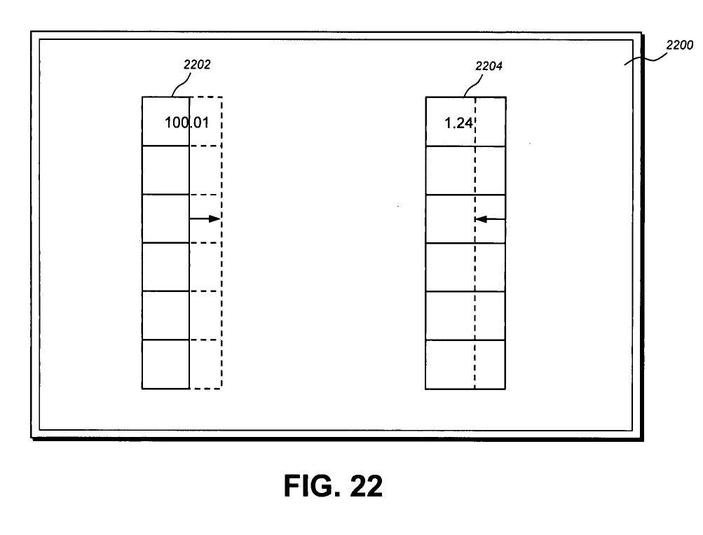

FIG. 22 illustrates a GUI 2200 according to the principles of the present invention (e.g. as described herein in connection with other embodiments) including columns of data 2202 and 2204 wherein the columns of data 2202 and 2204 auto-adjust in size to accommodate new data. In this embodiment, column 2202 receives new data “100.01” when the original column width was not large enough to accommodate the whole length of the number. The column 2202 auto-increases in size to fit the new information in a way that it is fully displayed or displayed to the desired extent. The system may be configured to auto-size before the new data is presented in the GUI, after the new data is presented in the GUI, during the process of being presented in the GUI or at another period. Column 2204 illustrates a column auto-fitting data according to the priniciples of the present invention where the new data presented is smaller than the overall capacity of the column. In this embodiment, the column auto-fits the new data “1.24” by shrinking. In embodiments where new information is presented and the new information does not fill the column and or row area, an assessment may be made of the other numbers and their associated column fits in the column. For example, other numbers in the column may be appropriately fit to their section of the column and the decision may be made to leave the column size alone even though the new data does not fill the allotted space.

An aspect of the present invention relates to refreshing of information presented on a GUI in connection with trading methods and systems presented herein. In certain situations, unregulated data refresh cycles may demand a trading computer to refresh the available data in large bursts in close proximity to each other. Embodiments of the present invention relate to regulating the refresh rate. For example, the refresh rate may be measured in microseconds, millisecond, tenths of seconds, or other measure. In a preferred embodiment, a refresh rate of approximately 20 ms may be chosen. In embodiments, information may be refreshed periodically and/or in real time. In embodiments, the display of market data may be controlled by specifying an interval of time that market data update requests should be ignored. For example, the interval of time for refreshing the information may be specified in thousandths, hundredths or tenths of seconds, seconds, minutes, hours, etc. and indicates how long market data update requests should be ignored. An interval of time of that is 0 may indicate that the display of market data should not ignore any market data requests and respond to all market data requests. An interval of time that is non 0 may indicate that the display of market data should ignore market data requests for the specified interval of time and display the current state of the market data when the interval of time elapses.

An aspect of the present invention relates to filters used in connection with trading systems and methods described herein. In embodiments, the volume of market data requests processed may be controlled by skipping market data requests that contain only changes to a quantity since the last market data request was processed. The volume of market data requests processed may be controlled by skipping market data requests that contain only changes to a bid quantity since the last market data request was processed. The volume of market data requests processed may be controlled by skipping market data requests that contain only changes to an ask quantity since the last market data request was processed. The volume of market data requests processed may be controlled by skipping market data requests that contain only changes to a plurality of bid quantities since the last market data request was processed. The volume of market data requests processed may be controlled by skipping market data requests that contain only changes to a plurality of ask quantities since the last market data request was processed. The volume of market data requests processed may be controlled by processing market data requests that contain a change to a bid price since the last market data request was processed. The volume of market data requests processed may be controlled by processing market data requests that contain a change to an ask price since the last market data request was processed. The volume of market data requests processed may be controlled by processing market data requests that contain changes to a plurality of bid prices since the last market data request was processed. The volume of market data requests processed may be controlled by processing market data requests that contain changes to a plurality of ask prices since the last market data request was processed. The volume of market data requests processed may be controlled by processing market data requests that contain a quantity traded since the last market data request was processed. The volume of market data requests processed may be controlled by processing market data requests that contain a quantity bought since the last market data request was processed. The volume of market data requests processed may be controlled by processing market data requests that contain a quantity sold since the last market data request was processed.

An aspect of the present invention relates to connecting the movements of cursor icon to information within the GUI of a trading platform according to the principles of the present invention. In embodiments, the cursor may ‘follow’ a value automatically while the value moves within a display in a GUI allowing a trader or other participant the ability to view other information within the GUI while the cursor automatically maintains it's position relative to a value. In embodiments, the cursor may also act in a predetermined way upon certain mouse, keyboard or other user interface interaction. For example, the position of the cursor on the display device may change in response to information received without human intervention. The position of the cursor on the display device may change in response to human intervention superseding changes from responses to information received without human intervention. The position of the cursor on the display device may be over a grid that contains a plurality of data that may scroll up. The position of the cursor on the display device may be over a grid that contains a plurality of data that may scroll down. The position of the cursor on the display device may move in response to the plurality of data scrolling on the grid such that the position of the cursor will be over the same data item after the scrolling event occurred as before the scrolling event occurred. The position of the cursor on the display device may move in response to the plurality of data scrolling on the grid such that the position of the cursor will be off of the grid after the scrolling event has occurred. The position of the cursor on the display device may be over a graph that contains a plurality of data that may scroll up. The position of the cursor on the display device may be over a graph that contains a plurality of data that may scroll down. The position of the cursor on the display device may move in response to the plurality of data scrolling on the graph such that the position of the cursor will be over the same data item after the scrolling event occurred as before the scrolling event occurred. The position of the cursor on the display device may move in response to the plurality of data scrolling on the grid such that the position of the cursor will be off of the graph after the scrolling event has occurred.

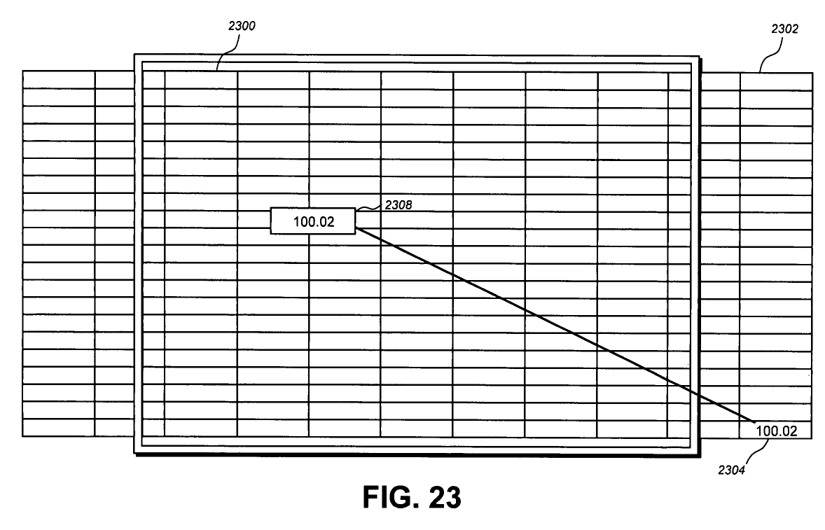

FIG. 23 illustrates a GUI 2300 according to the principles of the present invention (e.g. as described herein in connection with other embodiments) including the presentation of a table of data and or other information 2302. In this embodiment, the table 2302 is larger than the area available on the GUI and certain data of primary interest is not presented within the GUI. The information contained in table cell 2304 “100.02” is not within the GUI, but is present within the table. A trader, or other participant, may have a high interest in this data (e.g. due to a desire to trade quickly upon certain transient events). The trader may also want to look around at other areas of the spreadsheet. The cursor 2308 may be adapted to show the data within cell 2304. The mouse or other interface associated with the cursor may also be programmed to execute actions in relation to the data in cell 2304 (e.g. trade, bring back to the cell containing the data, bringing the trader to another screen associated with further available actions for the data). For example, once the cursor is associated with data within the GUI, it may also be programmed to bring a trader to a trade interface upon a single click of the mouse or keyboard. The system may also be adapted to make a trade automatically upon a single click.

An aspect of the present invention relates to methods and systems of electronic trading. In embodiments, the systems and methods may involve providing a user interface that displays a dynamic product price column with the current best bid and best ask prices continually shown as the column center rows despite changes in the market price of the product. The dynamic price column may display prices in contiguous increments with the current best bid and best ask prices continually shown as the center column rows. The dynamic price column may exclude prices that do not have order quantities associated with them in order to include prices that do have order quantities associated with them that would otherwise extend beyond the number of rows available to display in the column. Moving the cursor from one price to the next displayed price may display the next contiguous price that has been excluded in the dynamic price column. Moving the cursor from one price to the next displayed price may display a plurality of contiguous prices that have been excluded in the dynamic price column. Moving the cursor from one price to the next displayed price may display the next contiguous price that has been excluded outside of the dynamic price column. Moving the cursor from one price to the next displayed price may display a plurality of contiguous prices that have been excluded outside of the dynamic price column. In embodiments, the cursor follows the data value in real time. In embodiments, the cursor may not show a value, but it may be associated with data (e.g. with data within cell 2304) a click of the mouse or other user interface interaction may then bring the data or other associated information into the center of the GUI.

An aspect of the present invention relates to visual representations of trade history within a GUI according to the principles of the present invention. In embodiments, a visual representation of bid and or ask transaction history is presented on the GUI in coordination with current trading activity. For example, a visual representation of several previous executed trades may be presented, along with information pertaining to the trades (e.g. bid price, ask price, quantity transacted), in coordination with active market activity.

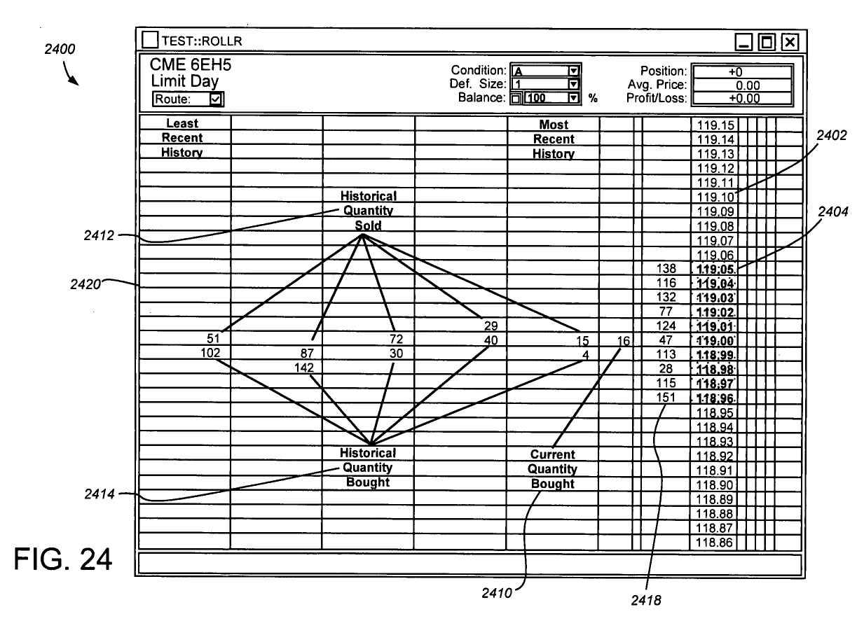

FIG. 24 illustrates a history presentation representation 2400 according to the principles of the present invention. In this embodiment, a GUI 2420 (e.g. similar to other GUIs presented herein) is presented including trade history information. A vertical column of bid and ask values 2402 is presented along with quantities of bids and asks 2418 available. Different colors, shades, patterns or other indications may be provided to separate bids from asks as well as where quantities are available. In this embodiment, the history of transactions moves from right to left where the most recent trades are on the right and the earlier trades are on the left. Historical sale quaitities 2412 are presented in red and are vertically aligned with an associated transaction price within the vertical column of values 2402. Likewise, the historical buy quantities 2414 are presented in blue and aligned vertically with an associated value within the vertical column of values 2402. This visualization provides a trader or other participant with visual perspective on how previous trades relate to other previous trades as well as current activity in the market and current transactions. The GUI may also include a current buy quantity 2410. The current buy quantity may be presented in a reverse video blue (with the cell block highlighted in blue) to make the current transaction standout in the GUI. Current market bid and ask quantities 2418 may be associated with prices in the pricing column 2402. Market bids may be presented in a particular color and asks in another color. In this embodiment, the GUI 2400 shows a new trading series starting with 16 contracts bought at 119.00 and 0 contracts sold with the starting trade being a buy as indicated by the blue reverse video. The most recent best bid of 118.99, as indicated by the blue “4” in the most recent history trading series, and the most recent best ask of 119.00, as indicated by the red “15” in the most recent history trading series, are centered within the display since the prices are dynamic and move up and down while the market is static and remains centered.

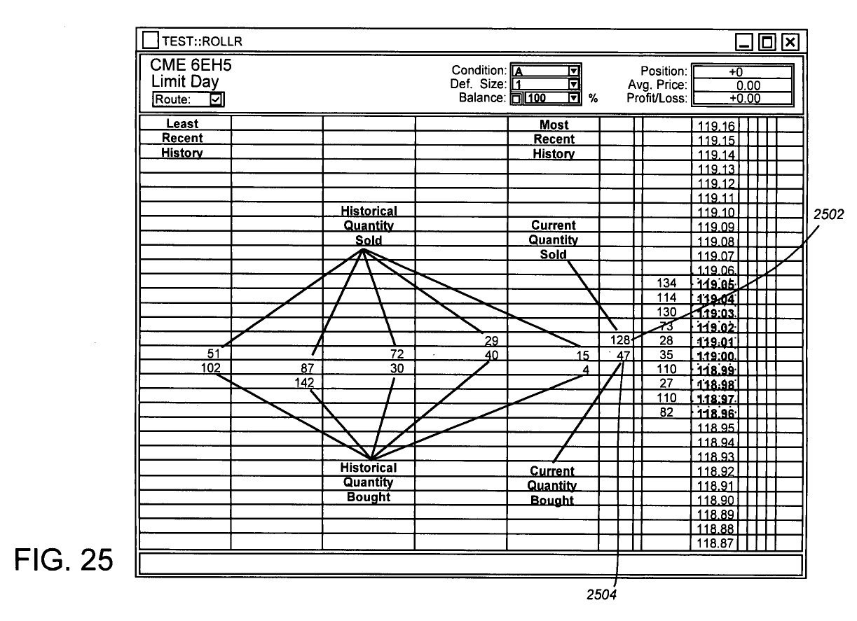

FIG. 25 illustrates another embodiment of trading history presented in a GUI (e.g. a step following the trading GUI screen of FIG. 24). In this embodiment, the GUI includes the total accumulation in the currently bought category 2504 thus far of 47 contracts bought at 119.00 and 128 contracts sold at 119.01 with the most recent trade being a sale as indicated by the red reverse video. The most current best bid of 119.00, as indicated by the blue “47” in the current trading series, and the most current best ask of 119.01, as indicated by the red reverse video “128” in the current trading series, are centered within the display since the prices are dynamic and move up and down while the market is static and remains centered.

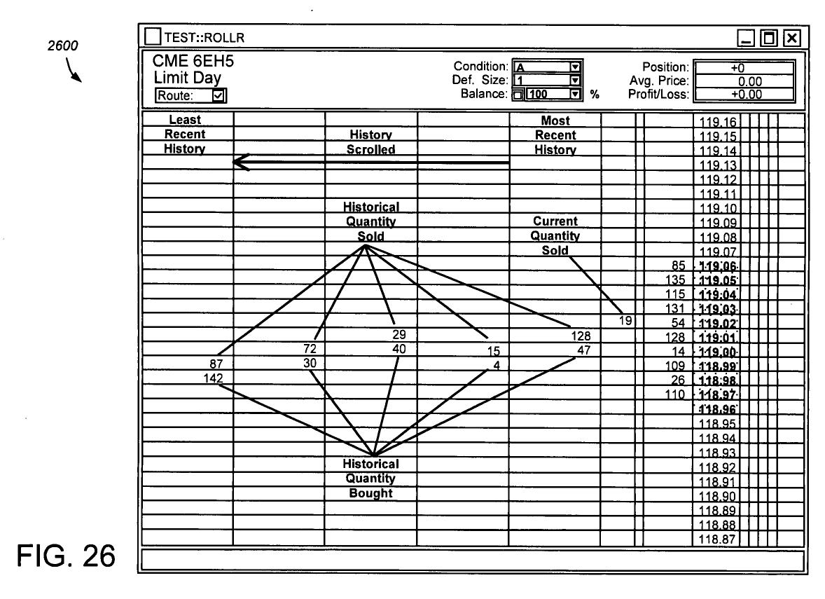

FIG. 26 illustrates another step in the trading cycle as a continuation of the trading illustrated and described in connection with FIGS. 24 and 25. In this embodiment, the GUI illustrates the most recent history trading series with the total accumulation of 47 contracts bought at 119.00 and 128 contracts sold at 119.01 scrolled into the most recent history and a new trading series starting with 19 contracts sold at 119.02 and 0 contracts bought with the starting trade being a sell as indicated by the red reverse video. The current best ask of 119.02, as indicated by the red reverse video 19 in the current trading series, and the current implied best bid of 119.01 are centered within the display since the prices are dynamic and move up and down while the market is static and remains centered.

In embodiments, when a product is traded on the buy side, the quantity bought is added to the previous total quantity bought at that price within the current trading series and the total quantity bought is displayed in reverse video with the total quantity sold within the current trading series displayed in normal video. In embodiments, when a product is traded on the sell side, the quantity sold is added to the previous total quantity sold at that price within the current trading series and the total quantity sold is displayed in reverse video with the total quantity bought within the current trading series displayed in normal video. In embodiments, the total quantity bought thus far within the current trading series is displayed in the row that corresponds to the current buy side price within the current trading series. In embodiments, the total quantity sold thus far within the current trading series is displayed in the row that corresponds to the current sell side price within the current trading series. In embodiments, the total quantities bought and sold thus far within the current trading series continue to accumulate within the current trading series until a market transition occurs. In embodiments, when a market transition occurs, the total quantity bought and total quantity sold within the current trading series scroll to the next column becoming the most recent historical trading series and the total quantities bought and total quantities sold within the current trading series are reset and a new trading series begins.

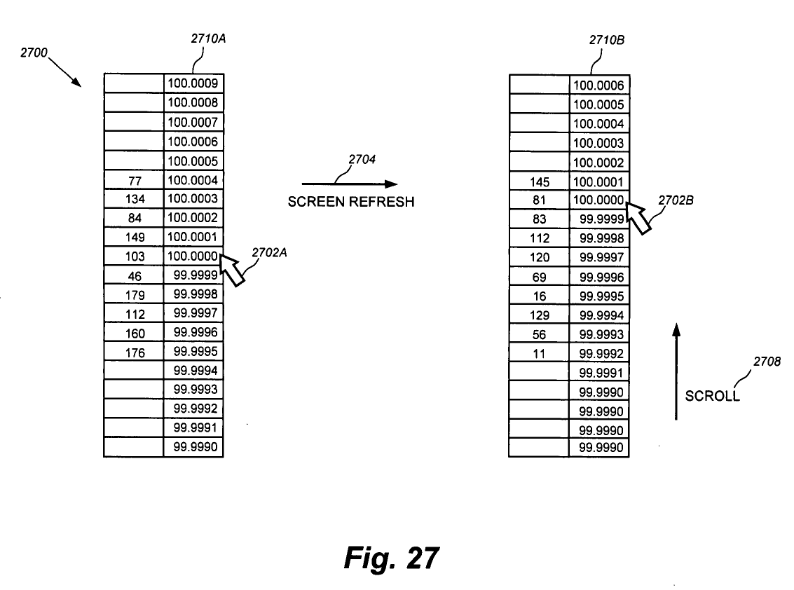

Another aspect of the present invention relates to locking a cursor on a trade, order, contract, value, volume or other parameter such that the cursor remains associated with the parameter as the information on a GUI moves. In embodiments, the cursor is locked on a price (e.g. a price in a column of prices as described herein) and the cursor moves up and down the column with the price as the column shifts up and down. This enables easy tracking and interaction with the price regardless of its movement within the GUI. For example, FIG. 27 illustrates a column of trade prices along with associated volumes in a GUI. The column may begin with a set of values in a column 2710A. A cursor 2702A may be positioned and associated with a value in the column. Then the column may scroll, shift, update or otherwise change into a new column of numbers presented in the GUI 2710B. The cursor will retain its association with the value it was originally associated with and as a result move automatically within the GUI to stay proximately associated with the value. This creates fast tracking of the value the participant is most interested in.

While the invention has been described in connection with certain preferred embodiments, other embodiments can be recognized by those of ordinary skill in the art and are encompassed herein.

1. A method, comprising:
presenting real-time financial market data in a user interface, wherein the user interface includes a plurality of adjacent cells containing proposed trade quantities with associated prices; and
presenting historical information including historical trade quantity and price information in the user interface; wherein the historical information scrolls on the screen as new real-time financial market data is added to the historical information.

2. The method of claim 1 wherein the historical information includes a plurality of trades.

3. The method of claim 1 wherein the historical information is presented in a vertical column.

4. The method of claim 1 wherein the historical information includes historical buy contract quantities.

5. The method of claim 1 wherein the historical information includes bid contract quantities.

6. The method of claim 1 wherein the historical information includes ask contract quantities.

7. The method of claim 1 wherein the historical information is presented horizontally.

8. The method of claim 1 wherein the historical information includes historical sell contract quantities.

9. The method of claim 8 wherein the historical information is presented horizontally.

10. The method of claim 1 wherein the historical information includes historical buy contract quantities and historical sell contract quantities.

11. The method of claim 10 wherein the historical buy contract quantities are presented in a different color from the historical sell contract quantities.

12. The method of claim 1 wherein the method further comprises presenting current trade information, wherein the current trade information is presented in association with the real-time financial market data.

13. The method of claim 1 wherein a current trade quantity is aligned in the user interface with an associated price in a column of the real-time financial market data.

14. The method of claim 13 wherein at least a portion of the real-time financial market data is presented in reverse video format.

15. The method of claim 1 wherein the user interface responds to a user entry of a quantity in a cell of the user interface by executing a trade.

16. A method of presenting information relevant to a trade, comprising:
providing a user interface associated with a trading system; and
displaying a scrolling bid-ask series in the user interface that includes an ask traded quantity and a bid traded quantity for one or more historical points in time.

17. The method of claim 16 wherein the scrolling bid-ask series includes a plurality of trades.

18. The method of claim 16 wherein scrolling bid-ask series is presented in a vertical column.

19. The method of claim 16 wherein scrolling bid-ask series is presented horizontally.

20. The method of claim 16 wherein the ask traded quantity and the bid traded quantity are presented in different colors.

21. The method of claim 20 wherein at least a portion of the scrolling bid-ask series is presented in reverse video format.

22. The method of claim 16 wherein the user interface responds to a user entry of a quantity in a cell of the user interface by executing a trade.

23-44. (canceled)
